(19) United States
(12) Patent Application Publication
(10) Pub. No.: US 2021/0115214 A1
(43) Pub. Date: Apr. 22, 2021

(54) POLYMER AEROGELS FABRICATED WITHOUT SOLVENT EXCHANGE

(71) Applicant: Blueshift Materials, Inc., Spencer, MA (US)

(72) Inventors: Muhammad EJAZ, San Marcos, TX (US); David J. Irvin, San Marcos, TX (US); Nicole Lambdin, San Marcos, TX (US); Garrett D. Poe, Spencer, MA (US)

(73) Assignee: Blueshift Materials, Inc., Spencer, MA (US)

(21) Appl. No.: 17/048,795

(22) PCT Filed: Apr. 25, 2019
(86) PCT No.: PCT/US2019/029191

§ 371 Date: Oct. 19, 2020

Related U.S. Application Data
(60) Provisional application No. 62/663,013, filed on Apr. 26, 2018.

(51) Int. Cl. C08J 9/28; B01J 13/00

(52) U.S. Cl. CPC C08J 9/286; B01J 13/0091; C08J 2379/08; C08J 2367/00; C08J 2201/026; C08J 2205/026; C08J 2201/0502; C08J 2201/0482; C08J 2333/08

(57) ABSTRACT

Disclosed is a method for producing an organic polymer aerogel and corresponding aerogels and articles of manufacture comprising such aerogels. The method can include polymerizing an organic polymerizable material in the presence of an organic solvent having a high vapor pressure and/or a low boiling point to obtain an organic polymer gel comprising an organic polymer matrix and the organic solvent, and subcritical or ambient drying the organic polymer gel under conditions suitable to remove the step (a) organic solvent and form an organic polymer aerogel.

### CROSS REFERENCE TO RELATED APPLICATIONS

This application claims priority to U.S. Provisional Application No. 62/663,013, filed Apr. 26, 2018, which is incorporated herein in its entirety without disclaimer.

### GOVERNMENT SUPPORT CLAUSE

This invention was made with government support under Contract Number DE-AR0000734 awarded by Advanced Research Projects Agency-Energy (ARPA-E) (U.S. Department of Energy). The government has certain rights in the invention.

### BACKGROUND OF THE INVENTION

### A. Field of the Invention

The invention generally concerns methods of fabricating polymeric aerogels without using solvent exchange. In particular, the invention concerns drying a polymer gel under conditions to remove the solvent or solvent system to form a polymeric aerogel, where solvent exchange has not been performed in formation of the polymer gel and/or drying of the polymer gel.

### B. Description of Related Art

A gel by definition is a sponge-like, three-dimensional solid network whose pores are filled with another non-gaseous substance, such as a liquid. The liquid of the gel is not able to diffuse freely from the gel structure and remains in the pores of the gel. Drying of the gel that exhibits unhindered shrinkage and internal pore collapse during drying provides materials commonly referred to as xerogels.

By comparison, a gel that dries and exhibits little or no shrinkage and internal pore collapse during drying can yield an aerogel. An aerogel is a light-weight material having a relatively low density and high porosity. Aerogels are used in a wide variety of applications such as building and construction, aerospace, transportation, catalysts, insulation, sensors, thickening agents, and the like. In instances where transparency and/or minimal haze are desired (e.g., windows, bottles, containers, optics (e.g., ophthalmic lenses), light bulbs, etc.), aerogels have generally failed. For instance, while aerogels made from silica (SiO₂) can exhibit high transparency, such silica aerogels are known to be brittle and therefor have low mechanical strength. This limits their use in applications where transparency is desired.

Conventional methods to produce polymeric aerogels include formation of a polymer gel, solvent exchange, and then drying of the solvent exchanged gel to produce the aerogel. Solvent exchange has been viewed as a necessary step, as removal of the reaction solvent can lead to pore collapse and ultimately low porosity of the final aerogel. Parameters that influence the solvent choice for solvent exchange and/or drying times can include surface tension, boiling point, evaporation rate, solubility parameters, vapor pressure, etc. Solvent exchange can be time and cost intensive and energy inefficient due the need to inhibit or reduce pore collapse. By way of example, solvent exchange can require large amounts of solvent (e.g., 5 times the volume of the solvent to be replaced in each solvent exchange cycle) and long processing times (e.g., 24 hours, 1 week or longer), which can limit the size of the aerogel to be produce. In addition, recapture and reuse of the solvent can require facilities capable of handling flammable and/or volatile materials, which can lead to high or increases manufacturing costs.

Attempts to produce surface modified aerogels without solvent exchange have been described. By way of example, U.S. Pat. No. 7,470,725 to Schwertfeger et al. describes obtaining a SiO₂ hydrogel, surface silyalting the hydrogel, solvent exchanging the water with a water miscible ketone or alcohol, and then drying the hydrogel under CO₂ atmosphere to form an aerogel. Attempts to produce organic aerogels without solvent exchange are described. By way of example, U.S. Pat. No. 6,077,876 to Mendenhall et al., describes producing aerogels from compounds that are soluble in alcohols using a molding/demolding process under supercritical conditions. However, organic compounds not soluble in alcohols required solvent exchange.

Despite the foregoing, processes to make aerogels are time intensive and suffer from complicated manufacturing steps.

### SUMMARY OF THE INVENTION

A discovery has been made that provides a solution to at least some of the aforementioned problems associated with the manufacture of aerogels. The discovery is premised on eliminating the need for solvent exchange and supercritical drying conditions and/or supercritical processing conditions by using an organic solvent having a high vapor pressure and/or a low boiling point to produce the aerogel precursor (e.g., a gel), and then drying the aerogel precursor under ambient or subcritical conditions to produce the aerogel. A benefit of the process of the present invention is that aerogels can be manufactured in an economically feasible manner on a large scale without pore collapse during drying. The solvent or solvent system can include a low boiling solvent, a high vapor pressure solvent, or combinations thereof. In some instances, the solvent or solvent system can be a combination of a low boiling solvent and a high vapor pressure solvent. By way of example, and as discovered in the context of the present invention, the higher vapor pressure solvent (higher boiling point) can be a “bad” (a non-Flory-Huggins) solvent for the aerogel precursor and has a high evaporation rate (i.e. high vapor pressure). This bad solvent in combination with a lower boiling solvent can produce an aerogel without solvent exchange. Without wishing to be bound by theory, it is believed that as the lower boiling solvent begins to evaporate, the solution is enriched in the higher vapor pressure solvent and/or remains in the polymer matrix. Since the higher vapor pressure solvent is a poor solvent, the aerogel precursor can dewet (or precipitate) for the solution. The resulting polymers are more rigid in nature as compared to polymers formed using conventional solvent systems. This rigid polymer matrix can help support the pores from collapse during drying.

In one aspect of the present invention, methods of producing organic polymer aerogels are described. A method can include (a) polymerizing an organic polymerizable material in the presence of an organic solvent or solvent system having a high vapor pressure and/or a low boiling point to obtain an organic polymer gel comprising an organic polymer matrix and the organic solvent or solvent system; and (b) subcritical drying or ambient drying the organic polymer gel to remove the step (a) organic solvent or solvent system and form an organic polymer aerogel. In some embodiment, the organic solvent or solvent system can have a vapor pressure of at least 15 kilopascal (kPa) or from 15 to 300 kPa, and/or a boiling point up to 250° C., preferably 50° C. to 250° C. In some instances the boiling point of the solvent or solvent system is up to 150° C., preferably 50° C. to 150° C. In some instances the boiling point of the solvent or solvent system is up to 125° C., preferably 50° C. to 125° C. In some instances, the boiling point of the solvent or solvent system is 200° C. to 250° C. or 200° C. to 205° C. (e.g., N-methyl-2-pyrrolidone (NMP)). Non-limiting examples of organic solvents that can be included in the organic solvent or solvent system include acetone, diethyl ether, tetrahydrofuran, hexane, heptane, isopropyl alcohol, a siloxane containing material (e.g., a methyl siloxane containing material, a hexamethyldisiloxane containing material, and the like), a mixture of fluorocarbon and trans-1,2-dichloroethylene, toluene, o-xylene, m-xylene, p-xylene, a mixture of xylenes, ethyl benzene, mesitylene, or combinations thereof. In one embodiment, the solvent or solvent system does not include alcohols. In some embodiments, the solvent or solvent system is a mixture of NMP and an alcohol or ketone solvent (e.g., isopropanol or tetrahydrofuran). Ambient drying can include evaporative drying or thermal drying. Evaporative drying can include removing the solvent under a stream of gas (e.g., air, or inert gas) at a temperature of 15° C. to 50° C., preferably 20° C. to 30° C. In some embodiments, ambient drying can include removing the solvent in the absence of a stream of gas (e.g., air, or inert gas) at a temperature of 15° C. to 50° C., preferably 20° C. to 30° C. Subcritical drying can include subjecting the organic polymer gel to conditions sufficient to freeze the solvent to form a frozen material, and subjecting the frozen material to a subcritical drying step sufficient to form the aerogel. In some embodiments, the solvent can be removed over a period of days. In other embodiments, the solvent can be removed in a closed container under atmospheric pressure.

In some embodiments, the step (a) polymeric matrix can be a polyimide polymer matrix. In such embodiments, the polymerizable material in step (a) can be a mixture of a multifunctional amine, a dianhydride, and a diamine and the polymer matrix is a polyimide polymer matrix. In some embodiments, the polyimide polymer matrix contains less than 5 wt. % of crosslinked polymers. In certain embodiments, the polyimide polymer matrix can include a polyamic amide compound, which can be converted to a polyimide by heating the aerogel.

In other embodiments, the step (a) polymer matrix can be a cross-linked polyester matrix and the polymerizable material in step (a) can be a mixture of unsaturated polyester compound and least one functionalized compound having an alkenyl group and the polymer matrix is a cross-linked polyester polymer matrix. The unsaturated polyester can have the general structure of:

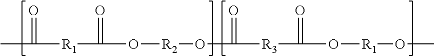

where R₁ is derived from an acid or anhydride moiety, R₂ is derived from a glycol or diol, and R₃ is an alkenyl group moiety capable of reacting with the compound having an alkenyl group to form the cross-linked polyester gel. The alkenyl group can be a vinyl group, an acrylate group, or combinations thereof. Non-limiting examples of vinyl groups include a vinyl group selected from the group consisting of styrene, 4-vinyl toluene, divinyl benzene, vinyl polyhedral oligomeric silsesquioxane (POSS), and combinations thereof.

In one aspect of the invention, the step (a) polymer is an organic cross-linked polyhedral oligomeric silsesquioxane (POSS) matrix. The POSS group can be crosslinked with an alkenyl group (e.g., a vinyl group, an acrylate group, or combinations thereof). In some instances, the alkenyl group can be styrene, 4-vinyl toluene, divinyl benzene, or combinations thereof. In a non-limiting example, the adamantane group is 1,3,5-trimethacryloyloxy adamantane and the vinyl group is divinyl benzene.

In another aspect of the present invention, methods of producing POSS polymer aerogels are described. The method can include (a) reacting a multi-functionalized POSS material with an organic linker group, and optionally a polymerizable organic monomer in the presence of an organic solvent or solvent system having a high vapor pressure and/or a low boiling point to obtain polymer gel comprising an organically cross-linked POSS polymer matrix and the organic solvent or solvent system; and drying the polymer gel under conditions suitable to remove the step (a) organic solvent or solvent system and form an organically cross-linked POSS polymer aerogel. The organically modified multi-functionalized POSS material can be: [R₁—SiO_{1.5}]n, where R₁ is an organic linker group that has at least 2 carbon atoms and is capable of undergoing a chemical reaction with another identical or similar organic linker group to form a covalent bond between both linker groups, and n is between 4 and 12 (e.g., 6, 8, and 10). In a preferred embodiment, n is 8. R₁ can include a C₂ to C₁₀ acrylate group, C₂ to C₁₀ methacrylate group, a C₂ to C₁₀ vinyl group, or a C₂ to C₁₀ epoxide group. In some embodiments, a polymerizable organic monomer can be used.

Still further, and in certain non-limiting aspects, the polymeric matrices of the aerogels made by the processes of the present invention can include macropores (pores having a size of greater than 50 nm to 5000 nm), mesopores (pores having a size of 2 nm to 50 nm in diameter) and micropores (pores having a size of less than 2 nm in diameter).

In another aspect of the present invention, articles of manufacture that include the aerogels of the present invention are disclosed. Non-limiting examples of articles of manufacture include a thin film, monolith, wafer, blanket, core composite material, insulating material for residential and commercial windows, insulation material for transportation windows, insulation material for transparent light transmitting application, insulation material for translucent light transmitting application, insulation material for translucent lighting applications, insulation material for window glazing, a substrate for radiofrequency antenna, substrate for a sunshield, a substrate for a sunshade, a substrate for radome, insulating material for oil and/or gas pipeline, insulating material for liquefied natural gas pipeline, insulating material for cryogenic fluid transfer pipeline, insulating material for apparel, insulating material for aerospace applications, insulating material for buildings, cars, and other human habitats, insulating material for automotive applications, insulation for radiators, insulation for ducting and ventilation, insulation for air conditioning, insulation for heating and refrigeration and mobile air conditioning units, insulation for coolers, insulation for packaging, insulation for consumer goods, vibration dampening, wire and cable insulation, insulation for medical devices, support for catalysts, support for drugs, pharmaceuticals, and/or drug delivery systems, aqueous filtration apparatus, oil-based filtration apparatus, and solvent-based filtration apparatus, or any combination thereof.

Also disclosed in the context of the present invention are aspects 1-45. Aspect 1 includes a method of producing an organic polymer aerogel, the method comprising: (a) polymerizing an organic polymerizable material in the presence of an organic solvent or solvent system having a high vapor pressure and/or a low boiling point to obtain an organic polymer gel comprising an organic polymer matrix and the organic solvent; and (b) subcritical or ambient drying the organic polymer gel under conditions suitable to remove the step (a) organic solvent or solvent system and form an organic polymer aerogel. Aspect 2 is the method of aspect 1, wherein the solvent or solvent system has a vapor pressure of 15 kilopascal (kPa) to 300 kPa. Aspect 3 is the method of any one of aspects 1 to 2, wherein the solvent or solvent system has a boiling point of 50° C. to 250° C. Aspect 4 is the method of any one of aspects 1 to 3, wherein the solvent or solvent system comprises acetone, diethyl ether, tetrahydrofuran, hexane, heptane, a methyl siloxane containing material, a hexamethyldisiloxane containing material, a mixture of fluorocarbon and trans-1,2-dichloroethylene, toluene, o-xylene, m-xylene, p-xylene, a mixture of xylenes, ethyl benzene, mesitylene, a mixture of N-methyl-2-pyrrolidinone and isopropyl alcohol, or combinations thereof. Aspect 5 is the method of any one of aspects 1 to 4, wherein the step (b) drying step is subcritical drying, ambient drying, or both. Aspect 6 is the method of aspect 5, wherein the ambient drying step is evaporative drying. Aspect 7 is the method of aspect 5, wherein evaporative drying comprises removing the solvent under a stream of gas at a temperature of 15° C. to 50° C., preferably 20° C. to 30° C. Aspect 8 is the method of aspect 5, wherein ambient drying comprises removing the step (a) solvent without a stream of gas at a temperature of 15° C. to 50° C., preferably 20° C. to 30° C. Aspect 9 is the method of aspect 5, further comprising: subjecting the organic polymer gel to conditions sufficient to freeze the solvent to form a frozen material; and subjecting the frozen material to a subcritical drying step sufficient to form the aerogel. Aspect 10 is the method of any one of aspects 1 to 8, wherein step (b) comprises removing the solvent over a period of days. Aspect 11 is the method of any one of aspects 1 to 10, wherein the step (a) polymeric matrix is a polyimide polymer matrix. Aspect 12 is the method of aspect 11, wherein the polymerizable material in step (a) is a mixture of a multifunctional amine, a dianhydride, and a diamine and the polymer matrix is a polyimide polymer matrix. Aspect 13 is the method of aspect 12, wherein the polyimide polymer matrix contains less than 5% by weight of crosslinked polymers. Aspect 14 is the method of any one of aspects 11 to 13, wherein the polyimide polymer matrix comprises a polyamic amide compound. Aspect 15 is the method of aspect 14, further comprising heating the aerogel to convert the polyamic amide to a polyimide. Aspect 16 is the method of any one of aspects 1 to 15, wherein the step (a) polymer matrix is a cross-linked polyester matrix. Aspect 17 is the method of aspect 16, wherein the polymerizable material in step (a) is a mixture of unsaturated polyester compound and least one functionalized compound having an alkenyl group and the polymer matrix is a cross-linked polyester polymer matrix. Aspect 18 is the method of aspect 17, wherein the unsaturated polyester has the general structure of:

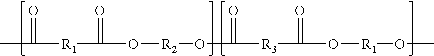

where R₁ is derived from an acid or anhydride moiety, R₂ is derived from a glycol or diol, and R₃ is an alkenyl group moiety capable of reacting with the compound having an alkenyl group to form the cross-linked polyester gel. Aspect 19 is the method of any one of aspects 17 to 18, wherein the alkenyl group is a vinyl group, an acrylate group, or combinations thereof. Aspect 20 is the method of aspect 18, wherein the compound has a vinyl group selected from the group consisting of styrene, 4-vinyl toluene, divinyl benzene, vinyl polyhedral oligomeric silsesquioxane (POSS), and combinations thereof. Aspect 21 is the method of any one of aspects 1 to 10, wherein the step (a) polymer matrix is a cross-linked adamantane matrix. Aspect 22 is the method of aspect 21, wherein the adamantane group is crosslinked with an alkenyl group. Aspect 23 is the method of any one of aspects 21 to 22, wherein the alkenyl group is a vinyl group, an acrylate group, or combinations thereof. Aspect 24 is the method of aspect 23, wherein the compound has a vinyl group selected from the group consisting of styrene, 4-vinyl toluene, divinyl benzene, and combinations thereof. Aspect 25 is the method of any one of aspects 23 to 24, wherein the adamantane group is 1,3,5-trimethacryloyloxy adamantane and the vinyl group is divinyl benzene. Aspect 26 is the method of any one of aspects 1 to 11, wherein the step (a) polymer matrix is a cross-linked POSS matrix. Aspect 27 is the method of aspect 26, wherein the POSS group is crosslinked with an alkenyl group. Aspect 28 is the method of any one of aspects 26 to 27, wherein the alkenyl group is a vinyl group, an acrylate group, or combinations thereof. Aspect 29 is the method of aspect 28, wherein the compound has a vinyl group selected from the group consisting of styrene, 4-vinyl toluene, divinyl benzene, and combinations thereof. Aspect 30 is the method of any one of aspects 26 to 29, wherein the adamantane group is 1,3,5-trimethacryloyloxy adamantane and the vinyl group is divinyl benzene. Aspect 31 is the method of any one of aspects 1 to 30, wherein the aerogel comprises macropores, mesopores, or micropores, or any combination thereof. Aspect 32 is the method of aspect 31, wherein the aerogel has an average pore size of greater than 50 nanometers (nm) to 5000 nm in diameter. Aspect 33 is the method of any one of aspects 1 to 32, wherein step (a) and step (b) does not include a solvent exchange process.

Aspect 34 is a method of producing a polymer aerogel, the method comprising: (a) reacting a multi-functionalized silsesquioxane (POSS) material with an organic linker group, and optionally a polymerizable organic monomer in the presence of an organic solvent or solvent system having a high vapor pressure and/or a low boiling point to obtain polymer gel comprising an organically cross-linked POSS polymer matrix and the organic solvent or solvent system; and (b) drying the polymer gel under conditions suitable to remove the step (a) organic solvent or solvent system and form an organically cross-linked POSS polymer aerogel. Aspect 35 is the method of aspect 34, wherein the organically modified multi-functionalized POSS material is:

[R₁—SiO_{1.5}]n,

where: R₁ is an organic linker group comprising a C₂ to C₁₀ acrylate group, a C₂ to C₁₀ vinyl group, or a C₂ to C₁₀ epoxide group; and n is between 4 and 12.

Aspect 36 is an aerogel made by the method of any one of aspects 1 to 33 or 34 to 35.

Aspect 37 is an article of manufacture comprising the aerogel of aspect 36. Aspect 38 is the article of manufacture of aspect 37, wherein the article of manufacture is a thin film, monolith, wafer, blanket, core composite material, a substrate for radiofrequency antenna, substrate for a sunshield, a substrate for a sunshade, a substrate for radome, insulating material for oil and/or gas pipeline, insulating material for liquefied natural gas pipeline, insulating material for cryogenic fluid transfer pipeline, insulating material for apparel, insulating material for aerospace applications, insulating material for buildings, cars, and other human habitats, insulating material for automotive applications, insulation for radiators, insulation for ducting and ventilation, insulation for air conditioning, insulation for heating and refrigeration and mobile air conditioning units, insulation for coolers, insulation for packaging, insulation for consumer goods, vibration dampening, wire and cable insulation, insulation for medical devices, support for catalysts, support for drugs, pharmaceuticals, and/or drug delivery systems, aqueous filtration apparatus, oil-based filtration apparatus, and solvent-based filtration apparatus, or any combination thereof. Aspect 39 is the article of manufacture of aspect 38, wherein the article of manufacture is an antenna. Aspect 40 is the article of manufacture of aspect 38, wherein the article of manufacture is a sunshield or sunscreen. Aspect 41 is the article of manufacture of aspect 38, wherein the article of manufacture is a radome. Aspect 42 is the article of manufacture of aspect 38, wherein the article of manufacture is a filter.

Aspect 43 is a method of producing an aerogel with a selected optical property, the method comprising: (a) polymerizing an organic polymerizable material in the presence of an organic solvent or solvent system having a high vapor pressure and/or a low boiling point to obtain an organic polymer gel comprising an organic polymer matrix and the organic solvent or solvent system, wherein the solvent or solvent system is selected based on the optical properties of the aerogel; and (b) subcritical or ambient drying the organic polymer gel under conditions suitable to remove the step (a) organic solvent or solvent system and form an organic polymer aerogel. Aspect 44 is the method of aspect 43, wherein the optical property is transparency and the solvent comprises an alcohol or ether, preferably isopropyl alcohol. Aspect 45 is the method of aspect 43, wherein the optical property is translucency or opaqueness and solvent comprises an aromatic hydrocarbon or a mixture of an aromatic hydrocarbon and a siloxane containing material, or a mixture of a siloxane containing compound and a an ether.

The following includes definitions of various terms and phrases used throughout this specification.

The term “aerogel” refers to a class of materials that are generally produced by forming a gel, removing a mobile interstitial solvent phase from the pores, and then replacing it with a gas or gas-like material. By controlling the gel and evaporation system, density, shrinkage, and pore collapse can be minimized. As explained above, aerogels of the present invention can include micropores, macropores, and/or mesopores or any combination thereof. The amount of micropores, macropores, and/or mesopores in any given aerogel of the present invention can be modified or tuned as desired. In certain preferred aspects, however, the aerogels can include mesopores such that at least 5%, 10%, 15%, 20%, 25%, 30%, 35%, 40%, 45%, 50%, 55%, 60%, 65%, 70%, 75%, 80%, 85%, 90%, 95%, or 100% of the aerogel's pore volume can be made up of mesopores. In some embodiments, the aerogels of the present invention can have low bulk densities (about 0.75 g/cm³ or less, preferably about 0.01 to 0.5 g/cm³), high surface areas (generally from about 0.15 to 600 m²/g and higher, preferably about 300 to 600 m²/g), high porosity (about 20% and greater, preferably greater than about 85%), and/or relatively large pore volume (more than about 0.3 mL/g, preferably about 1.2 mL/g and higher).

The term “hyperbranched” or “hyperbranched polymer” refers to a highly branched macromolecule with three-dimensional dendritic architecture. Hence, the molecular weight of a hyperbranched polymer is not a sufficient parameter that characterizes these polymers. Since the number of possible structures becomes very large as the polymerization degree of macromolecules increases, there is a need to also characterize this aspect of hyperbranched polymers. Thus, the term degree of branching (DB) can be used as a quantitative measure of the branching perfectness for hyperbranched polymers. In some embodiments, the hyperbranched POSS polymer aerogels can include a degree of branching (DB) of at least 2 or more branches per POSS polymer.

The presence of mesopores, macropores, and/or micropores in the aerogels of the present invention can be determined by mercury intrusion porosimetry (MIP) and/or gas physisorption experiments. MIP test used can be used to measure the mesopores and macropores above 5 nm (i.e., American Standard Testing Method (ASTM) D4404-10, Standard Test Method for Determination of Pore Volume and Pore Volume Distribution of Soil and Rock by Mercury Intrusion Porosimetry). Gas physisorption experiments can be used to measure micropores (i.e., ASTM D1993-03(2008) Standard Test Method for Precipitated Silica—Surface Area by Multipoint BET Nitrogen).

The terms “impurity” or “impurities” refers to unwanted substances in a feed fluid that are different than a desired filtrate and/or are undesirable in a filtrate. In some instances, impurities can be solid, liquid, gas, or supercritical fluid. In some embodiments, an aerogel can remove some or all of an impurity.

The term “desired substance” or “desired substances” refers to wanted substances in a feed fluid that are different than the desired filtrate. In some instances, the desired substance can be solid, liquid, gas, or supercritical fluid. In some embodiments, an aerogel can remove some or all of a desired substance.

The term “radio frequency (RF)” refers to the region of the electromagnetic spectrum having wavelengths ranging from 10⁻⁴ to 10⁷ m.

An “aliphatic group” is an acyclic or cyclic, saturated or unsaturated carbon group, excluding aromatic compounds. A linear aliphatic group does not include tertiary or quaternary carbons. Aliphatic group substituents include, but are not limited to halogen, hydroxyl, alkyoxy, haloalkyl, haloalkoxy, carboxylic acid, ester, amine, amide, nitrile, acyl, thiol and thioether. A branched aliphatic group includes at least one tertiary and/or quaternary carbon. Branched aliphatic group substituents can include alkyl, halogen, hydroxyl, alkyoxy, haloalkyl, haloalkoxy, carboxylic acid, ester, amine, amide, nitrile, acyl, thiol and thioether. A cyclic aliphatic group is includes at least one ring in its structure. Polycyclic aliphatic groups can include fused, e.g., decalin, and/or spiro, e.g., spiro[5.5]undecane, polycyclic groups. Cyclic aliphatic group substituents can include alkyl, halogen, hydroxyl, alkyoxy, haloalkyl, haloalkoxy, carboxylic acid, ester, amine, amide, nitrile, acyl, thiol and thioether.

An “alkyl group” is linear or branched, substituted or unsubstituted, saturated hydrocarbon. Alkyl group substituents may include, but are not limited to alkyl, halogen, hydroxyl, alkyoxy, haloalkyl, haloalkoxy, carboxylic acid, ester, amine, amide, nitrile, acyl, thiol and thioether.

An “aryl” or “aromatic” group is a substituted or unsubstituted, mono- or polycyclic hydrocarbon with alternating single and double bonds within each ring structure. Aryl group substituents can include alkyl, halogen, hydroxyl, alkyoxy, haloalkyl, haloalkoxy, carboxylic acid, ester, amine, amide, nitrile, acyl, thiol and thioether.

“High vapor pressure” when referring to an organic solvent or solvent system includes a vapor pressure of at least 15 kilopascal (kPa), preferably 15 to 300 kPa.

“Low boiling point” when referring to an organic solvent or solvent system includes a boiling point of 125° C. or less, preferably 50° C. to 125° C.

“Solvent system” includes the component(s) (e.g., one or more organic solvents) that can be used to fully or partially solubilize organic polymerizable material used to make the organic polymer aerogels of the present invention. Solvent systems can have (1) a high vapor pressure, (2) a low boiling point, (3) a high vapor pressure and a low boiling point, or (4) a high vapor pressure and a boiling point of greater than 125° C.

The term “acrylate” includes substituted and unsubstituted vinyl carboxylic acids. A general structure of an acrylate is

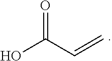

Non-limiting examples of acrylate include acrylate and methacrylate.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The aerogels of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the aerogels of the present invention are the ability to produce such aerogels without using a solvent exchange step.

### DETAILED DESCRIPTION OF THE INVENTION

A discovery has been made that solves at least some of the problems relating to manufacture of polymeric aerogels without using solvent exchange. The solution is premised on using the same solvent in the reaction mixture to form the polymeric matrix and dry the aerogel using ambient or subcritical drying. The organic solvent can have a high vapor pressure and/or a low boiling point.

A. Preparation of Polymer Aerogels

Aerogels of the present disclosure can be made using a multi-step process that includes 1) preparation of the polymer matrix gel, 2) drying of the polymeric solution to form the aerogel. These process steps are discussed in more detail below. As used herein “polymer gel” includes an “organic polymer gel” (e.g., imide polymer gel, a polyamic amide polymer gel, a cross-linked polyester gel).

1. Polymer Gels

Processes and methods to produce the polymer gel of the present invention can include reacting a polymerizable organic material or a polymerizable multi-functionalized POSS material (“polymer precursor material”) in the presence of an organic solvent having a high vapor pressure and/or a low boiling point under conditions sufficient to obtain a polymer gel. The reaction mixture can be subject to conditions suitable to form a polymer matrix and/or a reinforced polymer matrix. Non-limiting examples of polymer matrixes include polyimide polymer matrix, a polyamic amide polymer matrix, a cross-linked polyester matrix, hyperbranched organically modified POSS polymer matrix gel or these matrixes with fiber reinforcement. By way of example, the reaction mixture can be cast with or without agitation at a temperature of 15° C. to 120° C., or 65° C. to 75° C., or greater than, equal to, or between any two of 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C. and 120° C. for a time sufficient to form a gel (e.g., 1 minute to 24 hours, 2 to 15 hours, 5 to 10 hours). The reaction solvent and other reactants can be selected based on the compatibility with the materials. Non-limiting examples of the reaction solvent are found in the Solvents section below. An amount of polymer precursor material can range from 5 wt. % to 55 wt. %, 15 wt. % to 35 wt. %, or greater than, equal to, or between any two of 5 wt. %, 10 wt. %, 15 wt. %, 20 wt. %, 25 wt. %, 30 wt. %, 35 wt. %, 40 wt. %, 45 wt. %, 50 wt. %, and 55 wt. %. In a specific embodiment, the reaction solvent is tetrahydrofuran. Radical initiators, promoters, and chain transfer agents can be 0.001 to 0.5 wt. %. In some embodiments, promoter and/or chain transfer agents can be added to the solution. The optical properties of the aerogel can be tuned by varying the amount or type of polymer precursor material used. By way of example, using 15 wt. % to 35 wt. % or 15 wt. % to 100 wt. % of a POSS material (IV) can result in a transparent aerogel. In one non-limiting instance where opaque or translucent aerogels are produced, greater than 55 wt. % of the organically modified multi-functionalized POSS material can be added. Polymer precursor materials are described in detail in the Materials section of the application. Reaction conditions to prepare polymer matrixes are described U.S. Patent Application Publication No. 2017/0121483 to Poe et al., and International Patent Application Publication Nos. WO 2017078888 to Sakaguchi et al. and WO 2017/095527 to Sakaguchi et al., all of which are incorporated herein by reference.

In some embodiments, the polymer matrix solution can be cast onto a casting sheet covered by a support film for a period of time. In certain embodiments, the casting sheet is a polyethylene terephthalate (PET) casting sheet. Casting can include spin casting, gravure coating, three roll coating, knife over roll coating, slot die extrusion, dip coating, Meyer rod coating, or other techniques. In some instances, the cast film can then be heated in stages to elevated temperatures to remove solvent and convert, for example, the amic acid functional groups in the precursor to polyamic amide through amidation with an appropriate nitrogen containing hydrocarbon, to polyimide by imidization, or by applying appropriate conditions to afford a mixed copolymer. After a passage of time, the polymerized gel can be removed from the casting sheet. Alternatively, the polymer matrix solution can be placed into a mold to obtain a desired shape/stock shape of the gel. The polymerized gel includes a polymer matrix and the solvent from the reaction conditions. The polymerized gel has not undergone a solvent exchange during or after formation of the polymerized gel.

2. Cooling and Drying

In some embodiments, the polymerized gel can be dried to remove the solvent from the gel. The solvent is the same as that used to form the polymer matrix solution and the polymerized gel. Drying techniques can include subcritical drying, thermal drying, evaporative air-drying, ambient drying, or any combination thereof.

In another embodiment, the polymerized gel can be exposed to subcritical drying. In this instance, the gel can be cooled below the freezing point of the solvent and subjected to a freeze drying or lyophilization process to produce the aerogel. By way of example, the polymerized gel can be exposed to subcritical drying with optional heating after the majority of the solvent has been removed through sublimation. In this instance, the partially dried gel material is heated to a temperature near, or above, the boiling point of the solvent for a period of time. The period of time can range from a few hours to several days, although a typical period of time is approximately 4 hours. During the sublimation process, a portion of the solvent present in the polymerized gel has been removed, leaving a gel that can have macropores, mesopores, or micropores, or any combination thereof or all of such pore sizes. After the sublimation process is complete, or nearly complete, the aerogel has been formed.

In yet another embodiment, the polymerized gel can be dried under ambient conditions, for example, by removing the solvent under a stream of gas (e.g., air, anhydrous gas, inert gas (e.g., nitrogen (N₂) gas), etc. Still further, passive drying techniques can be used such as simply exposing the gel to ambient conditions without the use of a gaseous stream. By way of example, the gel can be placed in a solvent permeable container (e.g., a sealed polyolefin bag such as a polyethylene linear low density bag) or an impermeable containing having orifices to allow the solvent to leave the impermeable container and allowed to stand at 20° C. to 50° C. or ambient conditions until the solvent is removed from gel. In these instances, the solvent in the gel is removed by evaporation and pore collapse is prevented by the aerogel network. The drying may also be assisted by heating or irradiating with electromagnetic radiation.

3. Heat Treating of Polyamic Amide Aerogels

In some embodiments, a dried polyamic amide aerogel can be heat treated at 275° C. to 325° C. or 290° C. to 310° C. or greater than, equal to, or between any two of 275° C., 280° C., 285° C., 290° C., 295° C., 300° C., 305° C., and 310° C., to produce a heat treated polyimide aerogel that has less polyamic amide and/or polyamic acid than prior to heat treat. The heating can be performed under an inert atmosphere (e.g., nitrogen, argon, or helium atmosphere). While heat treating can remove a majority of the polyamic acid and/or polyamic amide, some polyamic acid or polyamic amide remains in the aerogel. After heat treating, the aerogel can be further dried under vacuum at a temperature of 250° C. to 275° C., or greater than, equal to, or between any two of 250° C., 255° C., 260° C., 265° C., 270° C., and 275° C. Drying under these conditions can remove any material not chemically bound to the polymer matrix (e.g., 2-methylimidazole).

B. Polymers and Materials

The materials, solvents, compounds, reagents and the like used to produce the polymer aerogels of the present invention can be made using known synthetic methods or obtained from commercial sources.

1. Polyimides and Polyamic Amide Polymers

Polyimides polymers can be used in production of aerogels with many desirable properties. In general, polyimide polymers include a nitrogen atom in the polymer backbone, where the nitrogen atom is connected to two carbonyl carbons, such that the nitrogen atom is somewhat stabilized by the adjacent carbonyl groups. A carbonyl group includes a carbon, referred to as a carbonyl carbon, which is double bonded to an oxygen atom. Polyimides are usually considered an AA-BB type polymer because usually two different classes of monomers are used to produce the polyimide polymer. Polyimides can also be prepared from AB type monomers. For example, an aminodicarboxylic acid monomer can be polymerized to form an AB type polyimide. Monoamines and/or mono anhydrides can be used as end capping agents if desired.

a. Polyimides

The polyimide of the current invention can have a repeating structural unit of:

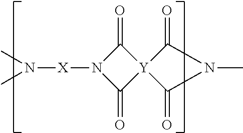

where X can be a first organic group having at least two carbon atoms and Y can be a second organic group having at least two carbon atoms, where X and Y are defined above. In some instances, the above polyimide polymer can be 2 to 2000 repeating units in length.

In one embodiment, the aerogel of the current invention is a branched polyimide having a general structure of:

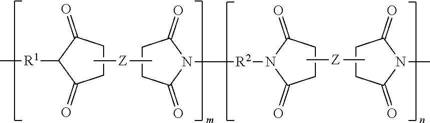

where R¹ is a hydrocarbon residue, a branched hydrocarbon residue, a heteroatom substituted hydrocarbon residue, a heteroatom substituted branched hydrocarbon residue, or a multifunctional amine residue, Z is a dianhydride residue; R² is a diamine residue, m is a number average per chain ranging from 0.5 to 1000, 0.5 to 500, 0.5 to 100, or specifically 0.5 to 10, and n is 1 to 1000, 1 to 500, 1 to 100, or specifically 1 to 25. In further embodiments, the aerogel composition branched polyimide can have a general structure of:

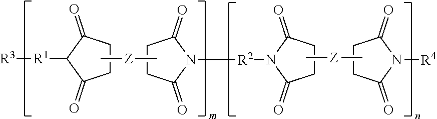

where R³ and R⁴ are each individually a capping group, R³ is preferably a hydrogen, or alkyl group and R⁴ is preferably an anhydride residue. Other non-limiting capping groups include amines, maleimides, nadimides, acetylene, biphenylenes, norbornenes, cycloalkyls, and N-propargyl and specifically those derived from reagents including 5-norbornene-2,3-dicarboxylic anhydride (nadic anhydride, NA), methyl-nadic anhydride, hexachloro-nadic anhydride, cis-4-cyclohexene-1,2-dicarboxylic anhydride, 4-amino-N-propargylphthalimide, 4-ethynylphthalic anhydride, and maleic anhydride.

As discussed above, polyimides can be prepared using solution chemistry. In one method, a di-acid monomer, usually in the form of a dianhydride, can be added to a solution containing an aromatic diamine in a solvent (e.g., polar aprotic solvent) or vice versa. For example, the di-acid monomer can be added first, or the di-acid monomer and the diamine can be simultaneously added. The resulting polycondensation reaction forms a polyamic acid, also referred to as a polyamide acid, which is a polyimide precursor. Other polyimide precursors are known, including polyamic ester, polyamic acid salts, polysilyl esters, and polyisoimides. This process description may be applicable to one or more polyimide precursor solutions. Alternatively, the polyimide can be formed from the forward or reverse mixing of amines and anhydrides under appropriate dehydrating conditions and/or catalysts where the lifetime of the polyamic acid intermediate is very short or possibly not even detectable. The polyimide polymer is formed by a cyclodehydration reaction, also called imidization. “Imidization” is defined as the conversion of a polyimide precursor into an imide. Alternatively, polyamic acids or other precursors may be converted in solution to polyimides by using a chemical dehydrating agent, catalyst, and/or heat.

In some aspects, the molar ratio of anhydride to total diamine is from 0.4:1 to 1.6:1, 0.5:1 to 1.5:1, 0.6:1 to 1.4:1, 0.7:1 to 1.3:1, or specifically from 0.8:1 to 1.2:1. In further aspects, the molar ratio of dianhydride to multifunctional amine (e.g., triamine) is 2:1 to 140:1, 3:1 to 130:1, 4:1 to 120:1, 5:1 to 110:1, 6:1 to 100:1, 7:1 to 90:1, or specifically from 8:1 to 125:1. The polyimide can also include a mono-anhydride group, including for example 4-amino-1,8-naphthalic anhydride, endo-bicyclo[2.2.2]oct-5-ene-2,3-dicarboxylic anhydride, citraconic anhydride, trans-1,2-cyclohexanedicarboxylic anhydride, 3,6-dichlorophthalic anhydride, 4,5-dichlorophthalic anhydride, tetrachlorophthalic anhydride 3,6-difluorophthalic anhydride, 4,5-difluorophthalic anhydride, tetrafluorophthalic anhydride, maleic anhydride, 1-cyclopentene-1,2-dicarboxylic anhydride, 2,2-dimethylglutaric anhydride 3,3-dimethylglutaric anhydride, 2,3-dimethylmaleic anhydride, 2,2-dimethylsuccinic anhydride, 2,3-diphenylmaleic anhydride, phthalic anhydride, 3-methylglutaric anhydride, methylsuccinic anhydride, 3-nitrophthalic anhydride, 4-nitrophthalic anhydride, 2,3-pyrazinedicarboxylic anhydride, or 3,4-pyridinedicarboxylic anhydride. In some embodiments, the di-anhydride group is phthalic anhydride.

b. Polyamic Amide Polymer

In some embodiments, the organic polymeric aerogel of the current invention includes a polymeric matrix having a polyamic amide polymer. The presence of the polyamic amide polymer can provide the aerogel with many improved properties over conventional polyimide aerogels. These improved properties can be obtained with low levels (i.e., less than 5 wt. %) of the polyamic amide polymer present in the aerogels. In some embodiments, the polymer aerogels contain little to no polyisoimide byproduct in the polymer matrix. In general, polyamic amide polymers include two amides that are part of the polymer backbone, and at least two additional amides that are not part of the polymer backbone. The at least two amides not part of the polymer backbone are free to rotate and interact with functional groups within and not within the polymer backbone. This structural arrangement may help to reduce the linearity and stiffness of the polymer backbone in a way to benefit the flexibility of the resultant aerogel while retaining or even increasing mechanical and thermal properties. The amides not part of the polymer backbone can also be variably functionalized with different amines to provide further opportunity for chemical interactions and the installation of further functionality to further affect aerogel properties. Similar to polyimide polymer, polyamic amide polymer can be considered an AA-BB type polymer because usually two different classes of monomers are used to produce the polyamic amide polymer. However polyamic amides are different than polyimides in that the intermediate polyamic acid derivative can be reacted with a free amine instead of cyclodehydration to form the polyimide. Polyamic amides can also be prepared from AB type monomers. For example, an aminodicarboxylic acid monomer can be polymerized to form an AB type intermediate polyamic acid that can be treated with a free amine under condition to form a polyamic amide. Monoamines and/or mono anhydrides can be used as end capping agents if desired.

The polyamic amide of the current invention can have a repeating structural unit of:

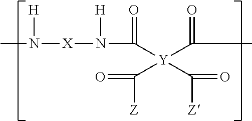

where X can be a first organic group having at least two carbon atoms, Y can be a second organic group having at least two carbon atoms, and Z and Z′ can each independently be a nitrogen containing hydrocarbon compound comprising at least one secondary nitrogen or a hydroxyl group. Z and Z′ can be the same or different groups. Z and Z′ can be a substituted or an unsubstituted cyclic compound, a substituted or an unsubstituted aromatic compound, or combinations thereof. In some instances, the above polyamic amide polymer can be 2 to 2000 repeating units in length. Z and Z′ can also include at least one tertiary nitrogen, and, in some instances, the secondary and tertiary nitrogen atoms are separated by at least one carbon atom. Non-limiting examples of Z and Z′ compounds include an imidazole or a substituted imidazole, a triazole or a substituted triazole, a tetrazole or substituted tetrazole, a purine or a substituted purine, a pyrazole or a substituted pyrazole, or combinations thereof. More specifically, Z and Z′ can have the following general structure:

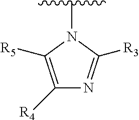

where R₃, R₄, and R₅ can be each individually a hydrogen (H) atom, an alkyl group, or a substituted alkyl group, an aromatic group or a substituted aromatic group, or R₄, and R₅ come together with other atoms to form a fused ring structure. In some instances, the imidazole can undergo electrophilic aromatic acylation to bond a carbon atom of the imidazole with the carbonyl carbon bonded to Y. An alkyl group can be a straight or branched chain alkyl having 1 to 20 carbon atoms and includes, for example, methyl, ethyl, propyl, isopropyl, butyl, isobutyl, secondary butyl, tertiary butyl, pentyl, isopentyl, neopentyl, hexyl, heptyl, octyl, 2-ethylhexyl, 1,1,3,3-tetramethylbutyl, nonyl, decyl, dodecyl, tetradecyl, hexadecyl, octadecyl, and eicosyl. A substituted alkyl group can be any of the aforementioned alkyl groups that are additionally substituted with a heteroatom, such as a halogen (F, Cl, Br, I), boron, oxygen, nitrogen, sulfur, silicon, etc. An aromatic group can be any aromatic hydrocarbon group having from 6 to 20 carbon atoms of the monocyclic, polycyclic or condensed polycyclic type, and include, for example, phenyl, biphenyl and naphthyl. A substituted aromatic group can be any of the aforementioned aromatic groups that are additionally substituted with a heteroatom, such as a halogen (F, Cl, Br, I), boron, oxygen, nitrogen, sulfur, silicon, etc. A fused ring structure includes, for example, benzimidazole. In some instances, the aforementioned alkyl group or substituted alkyl group has 1 to 12 carbon atoms, 2 to 6 carbon atoms, 3 to 8 carbon atoms, 5 to 12 carbon atoms, preferably 1 to 6 carbon atoms. In other instances, R₃ can be a methyl group or an ethyl group and R₄ and R₅ are H atoms, an alkyl group, or a substituted alkyl group. In some aspects, R₃ can be a methyl group, and R₄ and R₅ are H atoms, and, in other aspects, R₃ can be an ethyl group and R₄ and R₅ are each individually a H, an alkyl group, or a substituted alkyl, preferably, R₄ is a methyl group and R₅ is a H atom. The polyamic amide can have the following general structure when Z′ is an imidazole or substituted imidazole and Z is a hydroxyl group:

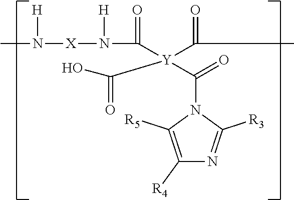

In a particular embodiment, the polyamic amide polymer is:

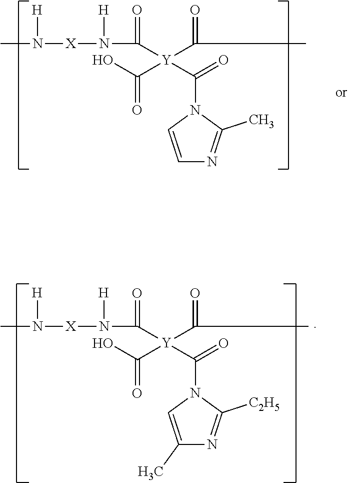

The polyamic amide polymer can be synthesized by several methods. In one non-limiting method of synthesizing the aromatic polyamic amide polymer, a solution of the aromatic diamine in a polar aprotic solvent, such as DMSO can be prepared. A di-acid monomer, usually in the form of a dianhydride, is added to this solution, but the order of addition of the monomers can be varied. For example, the di-acid monomer can be added first, or the di-acid monomer and the diamine can be simultaneously added. The resulting polycondensation reaction forms a polyamic acid, also referred to as a polyamide acid, which is a polyamic amide precursor. Other polyamic amide precursors are known, including polyamic ester, polyamic acid salts, polysilyl esters, and polyisoimides. Once the polyamic acid or derivative is formed, it can be further reacted with a nitrogen containing hydrocarbon and dehydration agent under conditions to form the polyamic amide polymer. The nitrogen containing hydrocarbon and dehydration agent together or separately may be present in solution, added during the reaction process, or added in a separate step as appropriate so the nitrogen containing hydrocarbon can be incorporated into the polyamic amide polymer by an amidation process. “Amidation” is defined as the conversion of a polyamic amide precursor into a polyamic amide. In some aspects, the molar ratio of a nitrogen containing hydrocarbon to anhydride or diamine monomer can be from 0.031:1 to 128:1, 0.12:1 to 32:1, or specifically from 0.5:1 to 10:1. The molar ratio of nitrogen containing hydrocarbon to dehydration agent can be from 01:1 to 44:1, 0.04:1 to 11:1, or specifically from 0.17:1 to 2.8:1. In general, amidation reactions, such as the reaction between a carboxylic acid and amine to form an amide bond are thermodynamically favorable, but often suffer from a high activation energy due acid-base chemistry between the carboxylic acid and amine. To overcome the high activation energy, amidation reactions often rely on non-acidic activation of the acid derivative. Activation can be achieved using a dehydration agent. For example, the activated acid derivative can be mixed with an acetic anhydride such as trifluoroacetic anhydride (TFAA) and trifluoroacetic acid (TFA) in toluene. In a preferred embodiment, amidation to form polyamic amide polymer can be achieved using an organic compound having at least one secondary amine. In one particular instance, an organic compound having a secondary and a tertiary amine, such as 2-methylimidazole or 2-ethyl-4-methylimidazole can be used. Without wishing to be bound by theory, it is believed that the secondary amine activates the polymer instead of the dehydration agent. The secondary amine containing organic compound can be added prior to or during addition of the dehydration agent. The dehydration agent can include acetic anhydride, propionic anhydride, n-butyric anhydride, benzoic anhydride, trifluoroacetic anhydride, oxalyl chloride, thionyl chloride, phosphorus trichloride, dicyclohexylcarbodiimide, 1,1′-carbonyldiimidazole (CDI), di-tert-butyl dicarbonate (Boc₂O), or combinations thereof. The reaction temperatures can be determined by a skilled chemist or engineer. In some embodiments, the reaction temperatures of one or more steps can range from 20° C. to 150° C., or greater than, equal to or between any two of 20° C., 30° C., 40° C., 50° C., 60° C., 70° C., 80° C., 90° C., 100° C., 110° C., 120° C., 130° C., 140° C., and 150° C. The resulting reaction mixture can be cast or provided to a mold.

c. Monomers

The characteristics or properties of the final polymer are significantly impacted by the choice of monomers, which are used to produce the polymer. Factors to be considered when selecting monomers include the properties of the final polymer, such as the flexibility, thermal stability, coefficient of thermal expansion (CTE), coefficient of hydroscopic expansion (CHE) and any other properties specifically desired, as well as cost. Often, certain important properties of a polymer for a particular use can be identified. Other properties of the polymer may be less significant, or may have a wide range of acceptable values; so many different monomer combinations could be used.

One class of monomer used to prepare the polymers and copolymers of the current invention can be a diamine, or a diamine monomer. The diamine monomer can also be a diisocyanate, and it is to be understood that an isocyanate could be substituted for an amine in this description, as appropriate. The other type of monomer can be an acid monomer, (e.g., a dianhydride) or a di-acid monomer. Di-acid monomers can include a dianhydride, a tetraester, a diester acid, a tetracarboxylic acid, or a trimethylsilyl ester, all of which can react with a diamine to produce a polyamic acid intermediate that can be used to prepare a polyamic amide polymer or copolymer. Dianhydrides are sometimes referred to in this description, but it is to be understood that tetraesters, diester acids, tetracarboxylic acids, or trimethylsilyl esters could be substituted, as appropriate. Because one di-acid monomer has two anhydride groups, different diamino monomers can react with each anhydride group so the di-acid monomer can become located between two different diamino monomers. The diamine monomer contains two amine functional groups; therefore, after the first amine functional group attaches to one di-acid monomer, the second amine functional group is still available to attach to another di-acid monomer, which then attaches to another diamine monomer, and so on. In this manner, the polymer backbone is formed. The resulting polycondensation reaction forms the polyamic acid.

The aerogel polymer compositions can be formed from two different types of monomers, and it is possible to mix different varieties of each type of monomer. Therefore, one, two, or more di-acid monomers can be included in the reaction vessel, as well as one, two or more diamino monomers. The total molar quantity of di-acid monomers is kept about the same as the total molar quantity of diamino monomers if a long polymer chain is desired. Because more than one type of diamine or di-acid can be used, the various monomer constituents of each polymer chain can be varied to produce aerogel polymer compositions with different properties. For example, a single diamine monomer AA can be reacted with two di-acid co monomers, B₁B₁ and B₂B₂, to form a polymer chain of the general form (AA-B₁B₁)ₓ-(AA-B₂B₂)_{y} in which x and y are determined by the relative incorporations of B₁B₁ and B₂B₂ into the polymer backbone. Alternatively, diamine co-monomers A₁A₁ and A₂A₂ can be reacted with a single di-acid monomer BB to form a polymer chain of the general form of (A₁A₁-BB)ₓ-(A₂A₂-BB)_{y}. Additionally, two diamine co-monomers A₁A₁ and A₂A₂ can be reacted with two di-acid co-monomers B₁B₁ and B₂B₂ to form a polymer chain of the general form (A₁A₁-B₁B₁)_{w}-(A₁A₁-B₂B₂)ₓ-(A₂A₂-B₁B₁)_{y}-(A₂A₂-B₂B₂)_{z}, where w, x, y, and z are determined by the relative incorporation of A₁A₁-B₁B₁, A₁A₁-B₂B₂, A₂A₂-B₁B₁, and A₂A₂-B₂B₂ into the polymer backbone. More than two di-acid co-monomers and/or more than two diamine co-monomers can also be used. Therefore, one or more diamine monomers can be polymerized with one or more di-acids, and the general form of the polymer is determined by varying the amount and types of monomers used.

There are many examples of monomers that can be used to make the aerogel polymer compositions of the present invention. In some embodiments, the diamine monomer is a substituted or unsubstituted aromatic diamine, a substituted or unsubstituted alkyldiamine, or a diamine that can include both aromatic and alkyl functional groups. Non-limiting examples of diamine monomers include 4,4′-oxydianiline (ODA), 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenylsulfones, 1,3-bis-(4-aminophenoxy)benzene, 1,3-bis-(3-aminophenoxy)benzene, 1,4-bis-(4-aminophenoxy)benzene, 1,4-bis-(3-aminophenoxy)benzene, 2,2-bis[4-(4-aminophenoxy)phenyl]-hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis-[4-(4-aminophenoxy)phenyl]sulfones, 2,2-bis[4-(3-aminophenoxy)phenyl]sulfones, bis(4-[4-aminophenoxy]phenyl)ether, 2,2′-bis-(4-aminophenyl)-hexafluoropropane, (6F-diamine), 2,2′-bis-(4-phenoxyaniline)isopropylidene, meta-phenylenediamine, para-phenylenediamine, 1,2-diaminobenzene, 4,4′-diaminodiphenylmethane, 2,2-bis(4-aminophenyl)propane, 4,4′diaminodiphenylpropane, 4,4′-diaminodiphenylsulfide, 4,4′-diaminodiphenylsulfone, 3,4′diaminodiphenylether, 4,4′-diaminodiphenylether, 2,6-diaminopyridine, bis(3-aminophenyl)diethyl silane, 4,4′-diaminodiphenyl diethyl silane, benzidine, dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-beta-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyletherphosphine oxide, 4,4′-diaminodiphenyl N-methylamine, 4,4′-diaminodiphenyl N-phenylamine, amino-terminal polydimethylsiloxanes, amino-terminal polypropyleneoxides, amino-terminal polybutyleneoxides, 4,4′-methylenebis(2-methylcyclohexylamine), 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-methylenebisbenzeneamine, 2,2′-dimethylbenzidine, (also known as 4,4′-diamino-2,2′-dimethyl biphenyl (DMB)), bisaniline-p-xylidene, 4,4′-bis(4-aminophenoxy)biphenyl, 3,3′-bis(4-aminophenoxy)biphenyl, 4,4′-(1,4-phenylenediisopropylidene)bisaniline, and 4,4′-(1,3-phenylenediisopropylidene)bisaniline, or combinations thereof. In a specified embodiment, the diamine monomer is ODA, DMB, or both.

A non-limiting list of possible dianhydride monomers include hydroquinone dianhydride, 3,3,4,4′-biphenyltetracarboxylic dianhydride (BPDA), pyromellitic dianhydride, 3,3′,4,4′-benzophenonetetracarboxylic dianhydride, 4,4′-oxydiphthalic anhydride, 3,3′,4,4′-diphenylsulfonetetracarboxylic dianhydride, 4,4′-(4,4′-isopropylidenediphenoxy)bis(phthalic anhydride), 2,2-bis(3,4-dicarboxyphenyl)propane dianhydride, 4,4′-(hexafluoroisopropylidene)diphthalic anhydride, bis(3,4-dicarboxyphenyl) sulfoxide dianhydride, polysiloxane-containing dianhydride, 2,2′,3,3′-biphenyltetracarboxylic dianhydride, 2,3,2′,3′-benzophenonetetraearboxylic dianhydride, naphthalene-2,3,6,7-tetracarboxylic dianhydride, naphthalene-1,4,5,8-tetracarboxylie dianhydride, 4,4′-oxydiphthalic dianhydride, 3,3′,4,4′-biphenylsulfonetetracarboxylic dianhydride, 3,4,9,10-perylene tetracarboxylic dianhydride, bis(3,4-dicarboxyphenyl)sulfide dianhydride, bis(3,4-dicarboxyphenyl)methane dianhydride, 2,2-bis(3,4-dicarboxyphenyl)propane dianhydride, 2,2-bis(3,4-dicarboxyphenyl)hexafluoropropane, 2,6-dichloronaphthalene-1,4,5,8-tetracarboxylic dianhydride, 2,7-dichloronapthalene-1,4,5,8-tetracarboxylic dianhydride, 2,3,6,7-tetrachloronaphthalene-1,4,5,8-tetracarboxylic dianhydride, phenanthrene-, 8,9,10-tetracarboxylic dianhydride, pyrazine-2,3,5,6-tetracarboxylic dianhydride, benzene-1,2,3,4-tetracarboxylic dianhydride, and thiophene-2,3,4,5-tetracarboxylic dianhydride, or combinations thereof. In a specific embodiment, the dianhydride monomer is BPDA, pyromellitic dianhydride, or both.

In some aspects, the molar ratio of anhydride to total diamine is from 0.4:1 to 1.6:1, 0.5:1 to 1.5:1, 0.6:1 to 1.4:1, 0.7:1 to 1.3:1, or specifically from 0.8:1 to 1.2:1. In further aspects, the molar ratio of dianhydride to multifunctional amine (e.g., triamine) is 2:1 to 140:1, 3:1 to 130:1, 4:1 to 120:1, 5:1 to 110:1, 6:1 to 100:1, 7:1 to 90:1, or specifically from 8:1 to 80:1. The polymer can also include a mono-anhydride group, including for example 4-amino-1,8-naphthalic anhydride, endo-bicyclo[2.2.2]oct-5-ene-2,3-dicarboxylic anhydride, citraconic anhydride, trans-1,2-cyclohexanedicarboxylic anhydride, 3,6-dichlorophthalic anhydride, 4,5-dichlorophthalic anhydride, tetrachlorophthalic anhydride 3,6-difluorophthalic anhydride, 4,5-difluorophthalic anhydride, tetrafluorophthalic anhydride, maleic anhydride, 1-cyclopentene-1,2-dicarboxylic anhydride, 2,2-dimethylglutaric anhydride 3,3-dimethylglutaric anhydride, 2,3-dimethylmaleic anhydride, 2,2-dimethylsuccinic anhydride, 2,3-diphenylmaleic anhydride, phthalic anhydride, 3-methylglutaric anhydride, methylsuccinic anhydride, 3-nitrophthalic anhydride, 4-nitrophthalic anhydride, 2,3-pyrazinedicarboxylic anhydride, or 3,4-pyridinedicarboxylic anhydride. Specifically, the mono-anhydride group is phthalic anhydride.

In another embodiment, the polymer compositions used to prepare the aerogels of the present invention include multifunctional amine monomers with at least three primary amine functionalities. The multifunctional amine may be a substituted or unsubstituted aliphatic multifunctional amine, a substituted or unsubstituted aromatic multifunctional amine, or a multifunctional amine that includes a combination of an aliphatic and two aromatic groups, or a combination of an aromatic and two aliphatic groups. A non-limiting list of possible multifunctional amines include propane-1,2,3-triamine, 2-aminomethylpropane-1,3-diamine, 3-(2-aminoethyl)pentane-1,5-diamine, bis(hexamethylene)triamine, N′,N′-bis(2-aminoethyl)ethane-1,2-diamine, N′,N′-bis(3-aminopropyl)propane-1,3-diamine, 4-(3-aminopropyl)heptane-1,7-diamine, N′,N′-bis(6-aminohexyl)hexane-1,6-diamine, benzene-1,3,5-triamine, cyclohexane-1,3,5-triamine, melamine, N-2-dimethyl-1,2,3-propanetriamine, diethylenetriamine, 1-methyl or 1-ethyl or 1-propyl or 1-benzyl-substituted diethylenetriamine, 1,2-dibenzyldiethylenetriamine, lauryldiethylenetriamine, N-(2-hydroxypropyl)diethylenetriamine, N,N-bis(1-methylheptyl)-N-2-dimethyl-1,2,3-propanetriamine, 2,4,6-tris(4-(4-aminophenoxy)phenyl)pyridine, N,N-dibutyl-N-2-dimethyl-1,2,3-propanetriamine, 4,4′-(2-(4-aminobenzyl)propane-1,3-diyl)dianiline, 4-((bis(4-aminobenzyl)amino)methyl)aniline, 4-(2-(bis(4-aminophenethyl)amino)ethyl)aniline, 4,4′-(3-(4-aminophenethyl)pentane-1,5-diyl)dianiline, 1,3,5-tris(4-aminophenoxy)benzene (TAPOB), 4,4′,4″-methanetriyltrianiline, N,N,N′,N′-Tetrakis(4-aminophenyl)-1,4-phenylenediamine, a polyoxypropylenetriamine, octa(aminophenyl)polyhedral oligomeric silsesquioxane, or combinations thereof. A specific example of a polyoxypropylenetriamine is JEFFAMINE® T-403 from Huntsman Corporation, The Woodlands, Tex., USA. In a specific embodiment, the aromatic multifunctional amine may be 1,3,5-tris(4-aminophenoxy)benzene or 4,4′,4″-methanetriyltrianiline. In some embodiments, the multifunctional amine includes three primary amine groups and one or more secondary and/or tertiary amine groups, for example, N′,N′-bis(4-aminophenyl)benzene-1,4-diamine.

Non-limiting examples of capping agents or groups include amines, maleimides, nadimides, acetylene, biphenylenes, norbornenes, cycloalkyls, and N-propargyl and specifically those derived from reagents including 5-norbornene-2,3-dicarboxylic anhydride (nadic anhydride, NA), methyl-nadic anhydride, hexachloro-nadic anhydride, cis-4-cyclohexene-1,2-dicarboxylic anhydride, 4-amino-N-propargylphthalimide, 4-ethynylphthalic anhydride, and maleic anhydride.

In some instances, the backbone of the aerogel polymer compositions can include further substituents. The substituents (e.g., oligomers, functional groups, etc.) can be directly bonded to the backbone or linked to the backbone through a linking group (e.g., a tether or a flexible tether). In other embodiments, a compound or particles can be incorporated (e.g., blended and/or encapsulated) into the polymer structure without being covalently bound to the polymer structure. In some instances, the incorporation of the compound or particles can be performed during the any step of the reaction process. In some instances, particles can aggregate, thereby producing polyamic amide or polyimide having domains with different concentrations of the non-covalently bound compounds or particles.

In some embodiments, the aerogel composition (e.g., polyamic amide or polyimide) can include a hyperbranched polymer. A hyperbranched polymer is a highly branched macromolecule with three-dimensional dendritic architecture. Hence, the molecular weight of a hyperbranched polymer is not a sufficient parameter that characterizes these polymers. Since the number of possible structures becomes very large as the polymerization degree of macromolecules increases, there is a need to characterize also this aspect of hyperbranched polymers. Thus, the term degree of branching (DB) was introduced as a quantitative measure of the branching perfectness for hyperbranched polymers. In some embodiments, the branched polyimides of the current aerogels can include a degree of branching (DB) of at least 0.2, 0.3, 0.4, 0.5, or more branches per polyimide polymer chain. In further embodiments, DB may range from 0.2 to 10, preferably from 1.2 to 8, or more preferably from 3 to 7. In a particular embodiment, the degree of branching is 6.3. Alternatively, the DB may range from 0.2 to 5, preferably 0.2 to 1, more preferably 0.2 to 0.6, or even more preferably about 0.2 to 0.4, or about 0.32. In another aspect, the DB may range from 0.3 to 0.7, 0.4 to 0.6, or about 0.51. In some aspects, DB may be represented by the following equation:

$$\frac{2 {Q}_{T}}{3 - {Q}_{T} + 3 {Q}_{M} - 3 p}$$

where p is the extent of reaction, and Q_{T} and Q_{M} are parameters representing the fractions of monofunctional and trifunctional monomers at the beginning of the reaction according to the following equations:

$${Q}_{T} = \frac{3 {N}_{T}}{{N}_{M} + 2 {N}_{B} + 3 {N}_{T}}$$

$${Q}_{M} = \frac{{N}_{M}}{{N}_{M} + 2 {N}_{B} + 3 {N}_{T}}$$

where N_{T}, N_{M}, and N_{B} are the initial number of trifunctional, monofunctional, and bifunctional monomers, respectively.

2. Cross-Linked Polyester Polymers

The cross-linked polyester aerogels of the present invention can be derived from unsaturated polyester materials and a compound having an alkenyl group. Unsaturated polyesters can be made using known polycondensation reactions. The unsaturated polyester of the present invention can be formed from acid compounds and diols, or obtained from commercial vendors. Non-limiting examples of acid compounds can include isophthalic acid terephthalic acid, adipic acid, tetrachlorophthalic anhydride and tetrabromophthalic anhydride, phthalic anhydride, maleic anhydride, maleic acid, fumaric acid, or mixtures thereof. Non-limiting examples of diol compounds can include 1,3-propanediol, 1,4-butanediol, 2-methyl-1,3-propanediol, dibromoneopentyl glycol, tetrabromo bisphenol-A, propylene glycol, ethylene glycol, diethylene glycol, dipropylene glycol, neopentyl glycol or blends thereof, or mixtures thereof. In some embodiments, the unsaturated polyester can have the general formula of:

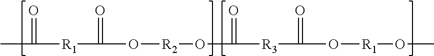

where R₁ can be derived from an acid moiety, R₂ can be derived from a diol, and R₃ can an alkenyl moiety. R₃ can be formed from an anhydride (e.g., maleic anhydride). R₃ can be capable of reacting with the compound having an alkenyl group to form the cross-linked polyester material. Unsaturated polyesters can be provided as a solution containing the unsaturated polyester and an alkenyl compound (e.g., styrene). Unsaturated polyester resins are also commercially available from, for example, Revchem Composites, Inc. (Stockton, Calif., USA).

Mono-, di-, or multi-functionalized compounds include compounds that have one or more (e.g., 1, 2, 3, 4, 5, 6, 7, 8, 9, 10, etc.) groups that can react with a double of the unsaturated polyester to connect two unsaturated polyester groups together (e.g., cross-link two unsaturated polyester compounds). Functionalized compounds can be made using organic synthetic methods or obtained from various commercial sources. Functionalized compounds of the present invention include one or more alkenyl groups. Alkenyl groups can include a vinyl group and/or an acrylate group. Non-limiting examples of compounds that include vinyl groups include styrene, 4-vinyl toluene, divinyl benzene, vinyl polyhedral oligomeric silsesquioxane (POSS), and combinations thereof. Non-limiting examples of compounds that include acrylate groups include methacrylate, methylmethacrylate, acrylo-POSS, methacrylo-POSS, or combinations thereof.

Vinyl- and acrylo-multi-functionalized POSS materials can be made using known synthetic copolymerization by a step growth condensation reaction between hydroxyl or alkoxide groups on the silsesquioxane and the appropriate functionality (e.g., R₁) on the silane or siloxane. Vinyl- and acrylo multi-functionalized POSS materials are also commercially available from Hybrid Plastics (Hattiesburg, Miss., USA). The vinyl- and acrylo multi-functionalized POSS materials of the present invention have the general structure of organically modified multi-functionalized POSS material of [R₁—SiO_{1.5}]n, where R₁ is vinyl group or an acrylate group (acrylo) and n is 6, 8, 10, or 12.

In a preferred embodiment, the POSS material has 8 repeating units and has the general structure of:

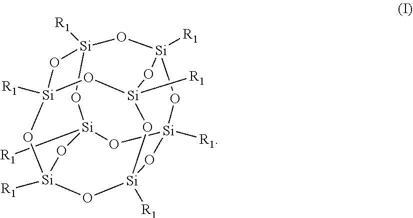

where R₁ is a vinyl or acrylo group. In certain non-limiting instances, vinyl, acrylo, and/or methacrylo-multi-functionalized POSS materials can have the following structures:

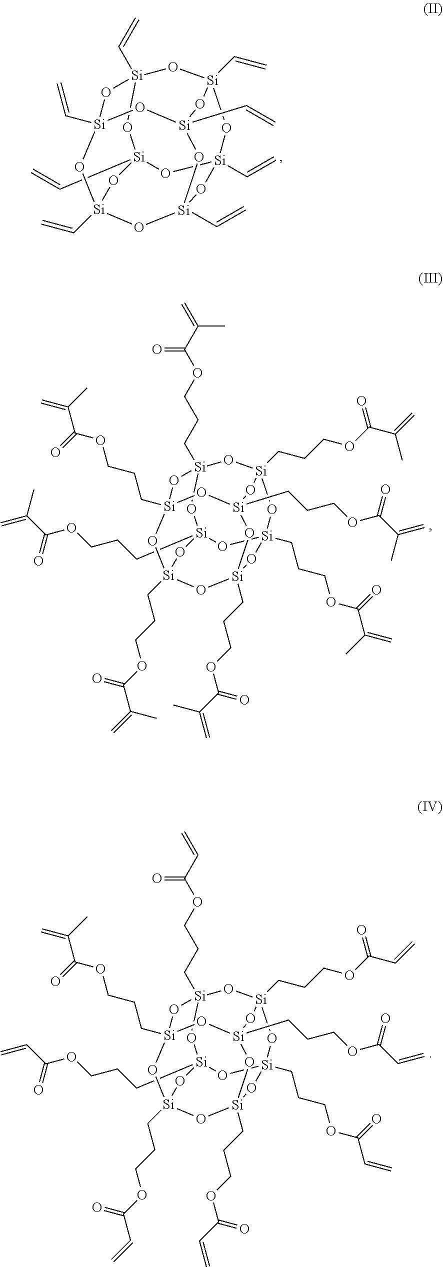

Radical initiators, promoters, and chain transfer agents can be used to assist in cross-linking the unsaturated polyester with the alkenyl compound. For example, radical initiators can produce radical species from an alkenyl compound to start the cross-linking process. Non-limiting examples of radical initiators can include azo compounds, peroxides, peroxyesters, ketone peroxides, or peroxyketal, or combinations thereof. A non-limiting example of the initiator is azobisisobutyronitrile (AIBN), benzoyl peroxide, methyl ethyl ketone peroxide, or the like. The choice of initiator can be selected based on the type of materials used. Promoters or co-catalyst can be used to regulate the reaction rate of the cross-linking. Non-limiting examples of promoters include cobalt (Co) compounds, copper naphthenate, and the like. Non-limiting examples of Co compounds include cobaloximines, cobalt porphyrins, Co(acac)₂, or cobalt naphthenate. Chain transfer agents are agents that can react with a chain carrier by a reaction in which the original chain carrier is deactivated and a new chain carrier is generated. Non-limiting examples of chain transfer agents include thiols (e.g., dodecane thiol) or halogenated hydrocarbons (e.g., carbon tetrachloride). Non-limiting examples of commercial suppliers of promoters, initiators, and chain transfer agents are Sigma-Aldrich® (U.S.A.), Wako Chemical (Japan), and Shepherd (U.S.A.).

3. Organically Modified Multi-Functionalized POSS Materials

The POSS polymer aerogels of the present invention can be derived from organically modified multi-functionalized POSS materials and optional organic monomers. In some embodiments, the organically modified multi-functionalized POSS materials can be made using known synthetic copolymerization by a step growth condensation reaction between hydroxyl or alkoxide groups on the silsesquioxane and the appropriate functionality (e.g., R₁) on the silane or siloxane. Organically modified multi-functionalized POSS materials are also commercially available from Hybrid Plastics (Hattiesburg, Miss., USA). The organically modified multi-functionalized POSS materials of the present invention have the general structure of organically modified multi-functionalized POSS material of [R₁—SiO_{1.5}]n, where R₁ is an organic linker group that has at least 2 carbon atoms and is capable of undergoing a chemical reaction and n can be between 4 and 12 (e.g., 6, 8, 10, or 12). R₁ can include a reactive group that has 2 to 10 carbon atoms (e.g., 2, 3, 4, 5, 6, 7, 8, 9, and 10). In some embodiments, the reactive group can be a C₂ to Cm acrylate group (e.g., acrylate, methacrylate or methylmethacrylate, butylacrylate groups), a C₂ to C₁₀ vinyl group (C₂H₃ group), or a C₂ to C₁₀ epoxide group (e.g., glycidyl isobutyl ether group). In some embodiment, the POSS material has 8 repeating units and has the structures I, II, III, IV and V shown above.

In some embodiments, additional monomers and/or polymerizable organic compounds with 1 to 10 functional groups can be added with the organically modified multi-functionalized POSS materials to produce the aerogels of the present invention. The additional monomers, for example, can be added to the solution that also includes the POSS materials prior to the formation of the gel. The additional monomers can react with the R₁ groups of the POSS materials to form covalent bonds. The monomers can be polymerized prior to or after reacting with the R₁ groups. The additional monomers can be used to link the POSS materials together to form the aerogel matrix. Non-limiting examples of monomers include alpha-olefins (e.g., ethylene propylene, or alpha-olefins have 2 to 20 carbons), dienes, vinyl aromatic monomers (e.g., styrene, vinyl toluene, t-butyl styrene, di-vinyl benzene, vinyl acetates, and all isomers or derivatives of these compounds), acrylates (e.g., methacrylate, methylmethacrylate, hexane diol diacrylate, and the like), unsaturated polyesters, epoxides (e.g. glycidyl compounds) and the like.

Radical initiators, promoters, and chain transfer agents can be used to assist in polymerization of the multi-functionalized POSS materials with each other or other monomers. Radical initiators can produce radical species from R₁ of the multi-functionalized POSS material to start the polymerization process. Non-limiting examples of radical initiators can include azobisisobutyronitrile (AIBN), 4,4′-azobis(4-cyanopentanoic acid) (ACPA), 2,2′-azobis(4-methoxy-2,4-dimethylvaleronitrile), benzoyl peroxide (BPO), methyl ethyl ketone peroxide (MEKP), and the like. Promoters or co-catalyst can be used to regulate the reaction rate of the polymerization. Non-limiting examples of promoters include cobalt (Co) compounds such as cobaloximines, cobalt porphyrins, Co(acac)₂, cobalt naphthenate, or combinations thereof. Chain transfer agents are agents that can react with a chain carrier by a reaction in which the original chain carrier is deactivated and a new chain carrier is generated. Non-limiting examples of chain transfer agents include thiols (e.g., 1-decane thiol or 1-dodecane thiol) or halogenated hydrocarbons (e.g., carbon tetrachloride). Non-limiting examples of commercial suppliers of promoters, initiators, and chain transfer agents are SigmaMillipore (U.S.A.), Wako Chemical (Japan), and Shepherd (U.S.A.).

The polymer aerogels of the present invention can have an open cell structure and can include at least two multi-functionalized POSS materials linked together through R₁. By way of example, multi-functionalized POSS material (IV) can polymerize with itself such that 1 to 8 POSS materials (IV) are added to an original POSS material (IV). Said another way, every R₁ of the POSS material covalently bonds with another R₁ of the same or different multi-functionalized POSS material to form a polymer having at least 2 to 9 or greater POSS materials. In some embodiments, the aerogel has a general formula of ([R₁—SiO_{1.5}]n)a, where n is 6, 8, 10 or 12 and a is 2 to infinity or 2 to 2×10¹⁰⁰, or 2×10³⁵, or 2×10²⁵. In some embodiments, the POSS polymer or hyperbranched POSS polymer aerogel can have a specific surface area of 0.15 m²/g to 1500 m²/g and higher, preferably 300 m²/g to 600 m²/g. The hyperbranched POSS polymer aerogel can have a haze value of 0.5 to 10, or greater than, equal to or between any two of 0.5, 1, 1.5, 2, 2.5, 3, 3.5, 4, 4.5, 5, 5.5, 6, 6.5, 7, 7.5, 8, 8.5, 9, 9.5, and 10, and/or a total percent light transmission of 10 to 99 greater than, equal to or between any two of 10, 15, 20, 25, 30, 35, 40, 45, 50, 55, 60, 65, 70, 75, 80, 85, 90, 95, and 99 at 550 wavelength, as measured by ASTM D1003. In some instances, the hyperbranched POSS polymer aerogel is transparent, translucent or opaque. In a preferred embodiment, the hyperbranched POSS polymer aerogel is transparent. In certain instances, the aerogels of the present invention can have a thickness of 1 mm to 100 mm or 1 mm to 25 mm, or greater than, equal to, or between any two of 1 mm 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm and 100 mm, and still retain their transparent characteristics. The hyperbranched aerogel can have a degree of branching (DB) of between 0.5 and 0.95, preferably between 0.65 and 0.95, or greater than, equal to, or between 0.5, 0.55, 0.6, 0.65, 0.70, 0.75, 0.80, 0.85, 0.90, and 0.95.

4. Polymerizable Adamantane Compounds

Polymerizable adamantane compounds can be used to make aerogels of the present invention. Polymerizable adamantane compounds having an alkenyl group can have the general structure of

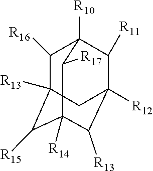

where at least one of R₁₀, R₁₁, R₁₂, R₁₃, R₁₄, R₁₅, R₁₆, and R₁₇ is a hydrogen, an alcohol, an amine, a alkyl group, a substituted alkyl group, an aromatic group, a substituted aromatic group, and a functionalized group that includes a polymerizable unsaturated group. Polymerizable groups include an alkenyl group, such as vinyl groups or acrylo groups. In some instances, the functionalized adamantane compound can have the structure.

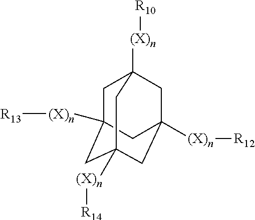

where (X)ₙ represents a connecting group that includes an ester bond or an amide bond, n is 0 or 1, and each X can be different according to R₁₀, R₁₂, R₁₃ and R₁₄ with the proviso that when n is 0 when R₁₀, R₁₂, R₁₃ or R₁₄ is a non-reactive atom or group. By way of example, X can be an ester bond at least one n is 1 and at least one R₁₀, R₁₂, R₁₃ or R₁₄ is a vinyl group or an isoprenyl group. Polymerizable adamantane compounds are available from commercial sources. A non-limiting commercial source is Mitsubishi Gas Chemical Company (Japan). Non-limiting examples of polymerizable adamant compounds include

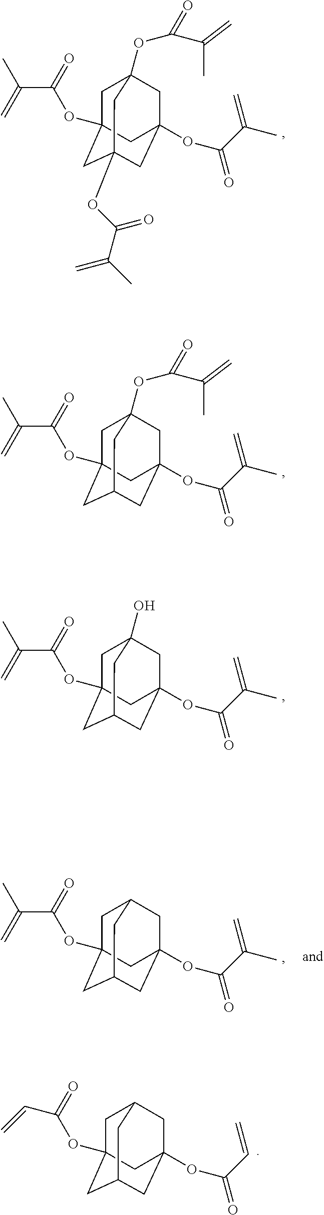

The polymerizable adamantane compounds can be polymerized with themselves or additional monomers. Additional monomers can be added with the polymerizable adamantane compounds to produce the aerogels of the present invention. The additional monomers, for example, can be added to the solution that also includes the polymerizable adamantane compounds prior to the formation of the gel. The additional monomers can react with the polymerizable groups of the adamantane to form covalent bonds. The monomers can be polymerized prior to or after reacting with the polymerizable groups of the adamantane compound. The additional monomers can be used to link the adamantane compounds together to form the aerogel matrix. Non-limiting examples of monomers include alpha-olefins (e.g., ethylene propylene, or alpha-olefins have 2 to 20 carbons), dienes, vinyl aromatic monomers (e.g., styrene, vinyl toluene, t-butyl styrene, di-vinyl styrene, vinyl acetates, and all isomers or derivatives of these compounds), acrylates (e.g., methacrylate, methylmethacrylate, diacrylates and the like), unsaturated polyesters, epoxides (e.g. glycidyl compounds) and the like.

5. Organic Solvents

Organic solvents used in the polymerization reaction can be low-boiling solvents, solvents with a high vapor pressure, solvents with a high vapor pressure and a low-boiling point, solvents with a high vapor pressure and a boiling point of greater than 125° C., or any combination of such solvents. At least one or more of these solvents can be used to create solvent systems having (1) a high vapor pressure, (2) a low boiling point, (3) a high vapor pressure and a low boiling point, or (4) a high vapor pressure and a boiling point of greater than 125° C. For the polymerization reaction, the solvent or solvent system can completely or partially solubilize the monomers and/or multi-functionalized POSS materials. Non-limiting examples of solvents or solvent systems for the polymerization reaction include acetone, tetrahydrofuran, diethyl ether, nitrogen-containing compounds, organosulfur compounds, ethers, hydrocarbons, nitro compounds, alcohols, ketones, halogenated compounds, esters, water, or mixtures thereof.

Non-limiting examples of nitrogen-containing compounds include formamide, N-methylformamide, N,N-dimethylformamide, N,N-diethylformamide, N,N-dimethylacetamide, N,N-diethylacetamide, 2-pyrrolidone, N-methyl-2-pyrrolidone (NMP), 1-methyl-2-pyrrolidinone, N-cyclohexyl-2-pyrrolidone, N-vinylacetamide, N-vinylpyrrolidone, hexamethylphosphoramide, and 1,13-dimethyl-2-imidazolidinone. Non-limiting examples of organosulfur compounds include dimethylsulfoxide, diethylsulfoxide, diethyl sulfoxide, methylsulfonylmethane, and sulfolane. Non-limiting examples of ether solvents include cyclopentyl methyl ether, di-tert-butyl ether, diethyl ether, diethylene glycol diethyl ether, diglyme, diisopropyl ether, dimethoxyethane, dimethoxymethane, 1,4-dioxane, ethyl tert-butyl ether, glycol ethers, methoxyethane, 2-(2-methoxyethoxy)ethanol, methyl tert-butyl ether, 2-methyltetrahydrofuran, morpholine, tetraglyme, tetrahydropyran, and triglyme. Non-limiting examples of hydrocarbons include benzene, cycloheptane, cyclohexane, cyclohexene, cyclooctane, cyclopentane, decalin, dodecane, durene, heptane, hexane, limonene, mesitylene, methylcyclohexane, naphtha, octadecene, pentamethylbenzene, pentane, pentanes, petroleum benzene, petroleum ether, toluene, tridecane, turpentine, ethylbenzene, o-xylene, m-xylene, p-xylene, mixtures of xylenes, and a mixture of mesitylene and xylene. Non-limiting example of nitro solvents include nitrobenzene, nitroethane, and nitromethane. Non-limiting examples of alcohols include methanol, ethanol, 1-propanol, 2-propanol, 1-butanol, 2-butanol, isobutanol, tert-butanol, 3-methyl-2-butanol, 3,3-dimethyl-2-butanol, 2-pentanol, 3-pentanol, 2,2-dimethylpropan-1-ol, cyclohexanol, diethylene glycol, tert-amyl alcohol, phenols, cresols, xylenols, catechol, benzyl alcohol, 1,4-butanediol, 1,2,4-butanetriol, butanol, 2-butanol, N-butanol, tert-butyl alcohol, diethylene glycol, ethylene glycol, 2-ethylhexanol, furfuryl alcohol, glycerol, 2-(2-methoxyethoxy)ethanol, 2-methyl-1-butanol, 2-methyl-1-pentanol, 3-methyl-2-butanol, neopentyl alcohol, 2-pentanol, 1,3-propanediol, and propylene glycolcycol. Non-limiting examples of ketones include hexanone, methyl ethyl ketone, methyl isobutyl ketone, disobutyl ketone, acetophenone, butanone, cyclopentanone, ethyl isopropyl ketone, 2-hexanone, isophorone, mesityl oxide, methyl isopropyl ketone, 3-methyl-2-pentanone, 2-pentanone, and 3-pentanoneacetyl acetone. Non-limiting examples of halogenated compounds include benzotrichloride, bromoform, bromomethane, carbon tetrachloride, chlorobenzene, 1,2-dichlorobenzene, 1,3-dichlorobenzene, 1,4-dichlorobenzene, chlorofluorocarbon, chloroform, chloromethane, 1,1-dichloro-1-fluoroethane, 1,1-dichloroethane, 1,2-dichloroethane, 1,1-dichloroethene, 1,2-dichloroethene, dichloromethane, diiodomethane, FC-75, haloalkane, halomethane, hex achlorobutadiene, hexafluoro-2-propanol, parachlorobenzotrifluoride, perfluoro-1,3-dimethylcyclohexane, perfluorocyclohexane, perfluorodecalin, perfluorohexane, perfluoromethylcyclohexane, perfluoromethyldecalin, perfluorooctane, perfluorotoluene, perfluorotripentylamine, tetrabromomethane, 1,1,1,2-tetrachloroethane, 1,1,2,2-tetrachloroethane, tetrachloroethylene, 1,1,1-tribromoethane, 1,3,5-trichlorobenzene-1,1,1-trichloroethane, 1,1,2-trichloroethane, trichloroethylene, 1,2,3-trichloropropane, 2,2,2-trifluoroethanol, and trihalomethane. Non-limiting examples of esters include methyl acetate, ethyl acetate, butyl acetate, 2-methoxyethyl acetate, benzyl benzoate, bis(2-ethylhexyl) adipate, bis(2-ethylhexyl) phthalate, 2-butoxyethanol acetate, sec-butyl acetate, tert-butyl acetate, diethyl carbonate, dioctyl terephthalate, ethyl acetate, ethyl acetoacetate, ethyl butyrate, ethyl lactate, ethylene carbonate, hexyl acetate, isoamyl acetate, isobutyl acetate, isopropyl acetate, methyl acetate, methyl lactate, methyl phenylacetate, methyl propionate, propyl acetate, propylene carbonate, dimethyl carbonate, and triacetin.

The solvent or solvent system can be chosen based on its vapor pressure at 20° C. to 50° C. and/or its boiling point. In some embodiments, the solvent or solvent system can have a vapor pressure at 20° C. to 50° C. of at least, equal to, or between any two of 15 kPa, 20 kPa, 30 kPa, 40 kPa, 50 kPa, 60 kPa, 70 kPa, 80 kPa, 90 kPa, 100 kPa, 110 kPa, 120 kPa, 130 kPa, 140 kPa, 150 kPa, 160 kPa, 170 kPa, 180 kPa, 190 kPa, 200 kPa, 210 kPa, 220 kPa, 230 kPa, 240 kPa, 250 kPa, 260 kPa, 270 kPa, 280 kPa, 290 kPa, and 300 kPa. In some instances, the solvent or solvent system can have a boiling point of at least any one of up to 250° C., equal to any one of, or between any two of −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., or 250° C. In some instances, the boiling point of the solvent or solvent system is 50° C. to 250° C. In some instances the boiling point of the solvent or solvent system is up to 150° C., preferably 50° C. to 150° C. In some instances the boiling point of the solvent or solvent system is up to 125° C., preferably 50° C. to 125° C. In some instances, the boiling point of the solvent or solvent system is greater than 125° C., preferably greater than 125° C. to 250° C. In some instances, the boiling point of the solvent or solvent system is at least 130° C., preferably 130° C. to 250° C. In some instances, the boiling point of the solvent or solvent system is at least 140° C., preferably 140° C. to 250° C. In some instances, the boiling point of the solvent or solvent system is at least 150° C., preferably 150° C. to 250° C. In some instances, the boiling point of the solvent or solvent system is at least 160° C., preferably 160° C. to 250° C. In some instances, the boiling point of the solvent or solvent system is at least 170° C., preferably 170° C. to 250° C. In some instances, the boiling point of the solvent or solvent system is at least 180° C., preferably 180° C. to 250° C. In some instances, the boiling point of the solvent or solvent system is at least 190° C., preferably 190° C. to 250° C. In some instances, the boiling point of the solvent or solvent system is at least 200° C., preferably 200° C. to 250° C. In some instances, the boiling point of the solvent or solvent system is 200° C. to 205° C. (e.g., NMP).

The solvent or solvent system can be chosen to obtain an aerogel having the desired physical properties such as optical properties and/or surface area. Optical properties include transparency, translucency, and opaqueness. For example a solvent that includes an aromatic hydrocarbon like xylene or toluene can be used to produce translucent, semi-transparent, or opaque aerogels. Solvents or solvent systems that include a siloxane containing material (e.g., methylsiloxane containing material) in combination with an aromatic hydrocarbon, an ether, or an alcohol can be used to make opaque aerogels. To produce transparent aerogels, ketone solvents, alcohols, nitrogen-containing solvents, or combinations thereof can be used. Solvents and solvent systems having a boiling point below 60° C. or combinations of solvents that have a ratio of high boiling solvent to low boiling solvent of 1:0.1 to 1:0.5 can be used to prepare an aerogel having a small specific surface area (e.g. 0.1 to 100 m²/g).

The aerogels of the present invention can include macropores (pores having a size of greater than 50 nm to 5000 nm), mesopores (pores having a size of 2 nm to 50 nm in diameter) and micropores (pores having a size of less than 2 nm in diameter). In some embodiments, the aerogels can have an average pore size of 1 to 10 nm. A pore volume of the aerogels can be from 0.1 to 1 cm³/g, or at least, equal to, or between any two of 0.1, 0.2, 0.3, 0.4, 0.5, 0.6, 0.7, 0.8, 0.9, and 1 cm³/g. Surface area of the aerogels of the present invention can range from high surface areas (generally from about 0.15 to 1000 m²/g and higher, or at least, equal to, or between any two of 0.15, 0.5, 0.75, 1.0, 10, 100, 200, 300, 400, 500, 600, 700, 800, 900, and 1000 m²/g).

C. Articles of Manufacture

The open-cell aerogel of the present invention can be included in an article of manufacture. For example, an article of manufacture can include a hyperbranched organically modified POSS polymer matrix, a polyimide, a polyamic amide, an adamantane-containing aerogel, or other aerogels of the present invention. In some embodiments, the article of manufacture is a thin film, monolith, wafer, blanket, core composite material, insulating material for residential and commercial windows, insulation material for transportation windows, insulation material for transparent light transmitting application, insulation material for translucent light transmitting application, insulation material for translucent lighting applications, insulation material for window glazing, core composite material, a substrate for radiofrequency antenna, substrate for a sunshield, a substrate for a sunshade, a substrate for radome, insulating material for oil and/or gas pipeline, insulating material for liquefied natural gas pipeline, insulating material for cryogenic fluid transfer pipeline, insulating material for apparel, insulating material for aerospace applications, insulating material for buildings, cars, and other human habitats, insulating material for automotive applications, insulation for radiators, insulation for ducting and ventilation, insulation for air conditioning, insulation for heating and refrigeration and mobile air conditioning units, insulation for coolers, insulation for packaging, insulation for consumer goods, vibration dampening, wire and cable insulation, insulation for medical devices, support for catalysts, support for drugs, pharmaceuticals, and/or drug delivery systems, aqueous filtration apparatus, oil-based filtration apparatus, and solvent-based filtration apparatus, or any combination thereof.

1. Fluid Filtration Applications

In some embodiments, the open-cell aerogel of the present invention can be used in fluid filtration systems and apparatus. A feed fluid can be contacted with the aerogels of the present invention such that some, all or, substantially all, of the impurities and/or desired substances are removed from the feed fluid to produce a filtrate essentially devoid of the impurities and/or desired substances. The filtrate, impurities, and/or desired substances can be collected, stored, transported, recycled, or further processed. The aerogel can be further processed to release the impurities and/or desired substances from the aerogel.

The polyamic amide aerogel described herein can be used in or with filtration apparatuses known in the art. Non-limiting examples of filtration apparatuses and applications include gas filters such as, but not limited to, building air filters, automotive cabin air filters, combustion engine air filters, aircraft air filters, satellite air filters, face mask filters, diesel particulate filters, in-line gas filters, cylinder gas filters, soot filters, pressure swing absorption apparatus, etc. Additional non-limiting examples of filtration apparatuses and applications include solvent filtration systems, column filtration, chromatography filtration, vacuum flask filtration, microfiltration, ultrafiltration, reverse osmosis filtration, nanofiltration, centrifugal filtration, gravity filtration, cross flow filtration, dialysis, hemofiltration, hydraulic oil filtration, automotive oil filtration, etc. Further, non-limiting examples of the purpose of filtration includes sterilization, separation, purification, isolation, etc.

A fluid for filtration (“feed”) and a filtrate can be any fluid. The fluid can be a liquid, gas, supercritical fluid, emulsion, or mixture thereof. In some instances, the liquid can be aqueous, non-aqueous, organic, non-organic, biological in origin, or a mixture thereof. In some instances, the gas can include air, nitrogen, oxygen, an inert gas, or mixtures thereof. In some instances, the liquid can contain solids and/or other fluids or be an emulsion. In particular instances the emulsion is a water-oil emulsion, an oil-water emulsion, a water-solvent emulsion, a solvent-water emulsion, an oil-solvent emulsion, or a solvent-oil emulsion. As non-limiting examples, the liquid can be water, blood, plasma, an oil, a solvent, air, or mixtures thereof. The solvent can be an organic solvent. Water can include water, any form of steam and supercritical water.

In some instances, the fluid can contain impurities. Non-limiting examples of impurities include solids, liquids, gases, supercritical fluids, objects, compounds, and/or chemicals, etc. What is defined as an impurity may be different for the same feed fluid depending on the filtrate desired. In some embodiments, one or more aerogels can be used to remove impurities. Non-limiting examples of impurities in water can include ionic substances such as sodium, potassium, magnesium, calcium, fluoride, chloride, bromide, sulfate, sulfite, nitrate, nitrites, cationic surfactants, and anionic surfactants, metals, heavy metals, suspended, partially dissolved, or dissolved oils, organic solvents, nonionic surfactants, defoamants, chelating agents, microorganisms, particulate matter, etc. Non-limiting examples of impurities in blood can include red blood cells, white blood cells, antibodies, microorganisms, water, urea, potassium, phosphorus, gases, particulate matter, etc. Non-limiting examples of impurities in oil can include water, particulate matter, heavy and/or light weight hydrocarbons, metals, sulfur, defoamants, etc. Non-limiting examples of impurities in solvents can include water, particulate matter, metals, gases, etc. Non-limiting impurities in air can include water, particulate matter, microorganisms, liquids, carbon monoxide, sulfur dioxide, etc.

In some instances, the feed fluid can contain desired substances. Desired substances can be, but are not limited to, solids, liquids, gases, supercritical fluids, objects, compounds, and/or chemicals, etc. In some embodiments, one or more aerogels can be used to concentrate or capture a desired substance, or remove a fluid from a desired substance. Non-limiting examples of desired substances in water can include ionic substances such as sodium, potassium, magnesium, calcium, fluoride, chloride, bromide, sulfate, sulfite, nitrate, nitrites, cationic surfactants, and anionic surfactants, metals, heavy metals, suspended, partially dissolved, or dissolved oils, organic solvents, nonionic surfactants, chelating agents, microorganisms, particulate matter, etc. Non-limiting examples of desired substances in blood can include red blood cells, white blood cells, antibodies, lipids, proteins, etc. Non-limiting examples of desired substances in oil can include hydrocarbons of a range of molecular weights, gases, metals, defoamants, etc. Non-limiting examples of desired substances in solvents can include particulate matter, fluids, gases, proteins, lipids, etc. Non-limiting examples of desired substances in air can include water, fluids, gases, particulate matter, etc.

The compatibility of an aerogel with a fluid and/or filtration application can be determined by methods known in the art. Some properties of an aerogel that may be determined to assess the compatibility of the aerogel may include, but is not limited to: the temperature and/or pressures that the aerogel melts, dissolves, oxidizes, reacts, degrades, or breaks; the solubility of the aerogel in the material that will contact the aerogel; the flow rate of the fluid through the aerogel; the retention rate of the impurity and/or desired product form the feed fluid; etc.

2. Radiofrequency (RF) Applications

Due to their low density, mechanical robustness, light weight, and low dielectric properties, the aerogels of the present invention can be used in radiofrequency (RF) applications. The use of aerogels of the present invention in RF applications enables the design of thinner substrates, lighter weight substrates and smaller substrates. Non-limiting examples of radiofrequency applications include a substrate for a RF antenna, a sunshield for a RF antenna, a radome, or the like. Antennas can include flexible and/or rigid antennas, broadband planar circuited antennas (e.g. a patch antennas, an e-shaped wideband patch antenna, an elliptically polarized circular patch antenna, a monopole antenna, a planar antenna with circular slots, a bow-tie antenna, an inverted-F antenna and the like). In the antenna design, the circuitry can be attached to a substrate that includes the aerogels of the present invention and/or a mixture of the aerogel and other components such as other polymeric materials including adhesives or polymer films, organic and inorganic fibers (e.g. polyester, polyamide, polyimide, carbon, glass fibers), other organic and inorganic materials including silica aerogels, polymer powder, glass reinforcement, etc. The use of aerogels of the present invention in antennas enables the design substrates with higher throughput. In addition, the aerogels of the present invention have coefficient of linear thermal expansion (CTE) similar to aluminum and copper (e.g., CTE of 23 ppm/K and 17 ppm/K), and is tunable through choice of monomer to match CTE of other desirable materials. In some embodiments, the aerogel can be used in sunshields and/or sunscreens used to protect RF antennas from thermal cycles due to their temperature insensitivity and RF transparency. In certain embodiments, the aerogel can be used as a material in a radome application. A radome is a structural, weatherproof enclosure that protects a microwave (e.g., radar) antenna. Aerogels of the present invention can minimize signal loss due to their low dielectric constant and also provide structural integrity due to their stiffness.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Preparation of Adamantane Aerogel in the Absence of Solvent Exchange

A solution of methyl ethyl ketone peroxide (0.7%, MEKPO) initiator was prepared in tetrahydrofuran (THF) solvent. 1,3,5-Tri-methacryloyloxy adamantane (ADTM, Mitsubishi Gas Chemical Company, JAPAN) and divinylbenzene (DVB) were mixed at 1:9 molar ratio and dissolved in the MEKPO/THF solution to produce a monomer/solvent solution (10 grams total) having a total monomer:solvent ratio of 30:70 with respect to mass. After purging with argon gas for 20 minutes, cobalt naphthenate (1.65 mg of 6% solution) was added to the mixture. After allowing to sit undisturbed at room temperature for 48 hours, a transparent, colorless, hard gel was formed without any visible cracks or defects. The polymer gel was dried in air via evaporation to produce a transparent aerogel having a specific surface area of 560 m²/g±3 m²/g as determined by Brunauer-Emmett-Teller (BET) surface area analysis and an average pore diameter of 3.5 nm as determined by Barrett-Joyner-Halenda (BJH) analysis, and a pore volume of 0.4 cm³/g as determined by density functional theory (DFT) utilizing a Micromeritics Gemini VII 2390 Series Surface Area Analyzer.

### Example 2

### Preparation of Adamantane Aerogel in the Absence of Solvent Exchange

A solution of benzoyl peroxide (1.1%, BPO) initiator was prepared in toluene solvent. ADTM, DVB, and 2,2,3,3,4,4,5,5-octafluoro-1,6-hexyl diacrylate (FHDDA) were mixed at 1:1.42:0.7 molar ratio and dissolved in the BPO/toluene solution to produce a monomer/solvent solution (20 grams total) having a total monomer:solvent ratio of 27:73 with respect to mass. To the above solution 1-decanethiol (54.52 mg) was added and purged with argon gas for 30 minutes. The solution was heated at 90° C. and a hard transparent gel was formed without any visible cracks or defects after 70 min. The polymer was further cured for 30 min more at 90° C. The polymer gel was dried in air via evaporation to produce a semitransparent aerogel having a specific surface area of 20.81 m²/g±3 m²/g as determined by Brunauer-Emmett-Teller (BET) surface area analysis and an average pore diameter of 4.2 nm as determined by Barrett-Joyner-Halenda (BJH) analysis, and a pore volume of 0.14 cm³/g as determined by density functional theory (DFT).

### Example 3

### Preparation of POSS-HDDA Aerogel in Xylene and in the Absence of Solvent Exchange

A solution of 2,2′-azobis(2-methylpropionate) (0.7%, AIBN) initiator was prepared in xylene solvent. Methyacrylopolyhedral oligomeric silsesquioxane (MAPOSS, Hybrid Plastics, Mississippi, USA) and 1,6-hexanediol diacrylate (HDDA, SigmaMillipore, USA) were mixed at 1:9 molar ratio and dissolved in the AIBN/xylene solution to produce a monomer/solvent solution (20 grams total) having a total monomer:solvent ratio of 30:70 with respect to mass. To the above solution 1-decanethiol (27.00 mg, SigmaMillipore, USA) was added and purged with argon gas for 30 minutes. The solution was heated at 90° C. and hard transparent gel was formed without any visible cracks or defects after 30 min. The polymer was further cured for 30 min more at 90° C. The polymer gel was dried in air via evaporation to produce a semitransparent aerogel having a specific surface area of 160 m²/g±3 m²/g as determined by Brunauer-Emmett-Teller (BET) surface area analysis and an average pore diameter of about 4.0 nm as determined by Barrett-Joyner-Halenda (BJH) analysis, and a pore volume of 0.13 cm³/g as determined by density functional theory (DFT) utilizing a Micromeritics Gemini VII 2390 Series Surface Area Analyzer.

### Example 4

### Preparation of POSS-HDDA Aerogel in Xylene the Absence of Solvent Exchange

A solution of AIBN (0.7%) initiator was prepared in xylene solvent. MAPOSS and HDDA were mixed at 1:9 molar ratio and dissolved in the AIBN/xylene solution to produce a monomer/solvent solution (20 grams total) having a total monomer:solvent ratio of 30:70 with respect to mass. To the above solution pentaerythritol tetrakis(3-mercaptopropionate) (20.00 mg, SigmaMillipore, USA) was added and purged with argon gas for 30 minutes. The solution was heated at 90° C. and hard transparent gel was formed without any visible cracks or defects after 28 min. The polymer was further cured for 30 min more at 90° C. The polymer gel was dried in air via evaporation to produce a semitransparent aerogel having a specific surface area of 300 m²/g±3 m²/g as determined by Brunauer-Emmett-Teller (BET) surface area analysis and an average pore diameter of 4.8 nm as determined by Barrett-Joyner-Halenda (BJH) analysis, and a pore volume of 0.31 cm³/g as determined by density functional theory (DFT) utilizing a Micromeritics Gemini VII 2390 Series Surface Area Analyzer.

### Example 5

### Preparation of POSS-HDDA Aerogel in Xylene the Absence of Solvent Exchange

A solution of AIBN (0.6%) initiator was prepared in xylene solvent. MAPOSS and HDDA were mixed at 1:1 molar ratio and dissolved in the AIBN/xylene solution to produce a monomer/solvent solution (20 grams total) having a total monomer:solvent ratio of 29:71 with respect to mass. To the above solution pentaerythritol tetrakis(3-mercaptopropionate (29.88 mg) was added and purged with argon gas for 30 minutes. The solution was heated at 90° C. and hard transparent gel was formed without any visible cracks or defects after 28 min. The polymer was further cured for 30 min more at 90° C. The polymer gel was dried in air via evaporation to produce an opaque aerogel having a specific surface area of 302 m²/g±3 m²/g as determined by Brunauer-Emmett-Teller (BET) surface area analysis and an average pore diameter of 4.8 nm as determined by Barrett-Joyner-Halenda (BJH) analysis, and a pore volume of 0.31 cm³/g as determined by density functional theory (DFT).

### Example 6

### (Preparation of POSS-HDDA Aerogel Xylene and Siloxane Solvent and in the Absence of Solvent Exchange

A solution of AIBN (0.7%) initiator was prepared in a 50% (w/w) mixture of xylene and methylsiloxane (Dow Corning® OS-10, USA). MAPOSS and HDDA were mixed at 1:1.8 molar ratio and dissolved in the AIBN/xylene/OS-10 solution to produce a 20 gram total mass of monomer/solvent solution having a total monomer:solvent ratio of 30:70 with respect to mass. To the above solution 1-decanethiol (21.00 mg, SigmaMillipore, USA) was added and purged with argon gas for 30 minutes. The solution was heated at 90° C. and an opaque gel was formed without any visible cracks or defects after 15 min. The polymer was further cured for 30 min more at 90° C. The polymer gel was dried in air via evaporation to produce a white and opaque aerogel having a specific surface area of 230 m²/g±3 m²/g as determined by Brunauer-Emmett-Teller (BET) surface area analysis and an average pore diameter of 6.9 nm as determined by Barrett-Joyner-Halenda (BJH) analysis, and a pore volume of 0.50 cm³/g as determined by density functional theory (DFT) utilizing a Micromeritics Gemini VII 2390 Series Surface Area Analyzer.

### Example 7

### Preparation of MAPOSS-HDDA Aerogel in a Xylene/OS-10 Mixture and in the Absence of Solvent Exchange

A solution of AIBN (0.7%) initiator was prepared in a 50% (w/w) mixture of xylene and OS-10. MAPOSS and HDDA were mixed at 1:1.8 molar ratio and dissolved in the AIBN/xylene/OS-10 solution to produce a monomer/solvent solution (20 grams total) having a total monomer:solvent ratio of 30:70 with respect to mass. To the above solution 1-decanethiol (21.00 mg) was added and purged with argon gas for 30 minutes. The solution was heated at 90° C. and a white opaque gel was formed without any visible cracks or defects after 15 min. The polymer was further cured for 30 min more at 90° C. The polymer gel was dried in a 50 micron thick Ziploc bag via evaporation to produce a white and opaque aerogel having a specific surface area of 240 m²/g±3 m²/g as determined by Brunauer-Emmett-Teller (BET) surface area analysis and an average pore diameter of 10 nm as determined by Barrett-Joyner-Halenda (BJH) analysis, and a pore volume of 0.40 cm³/g as determined by density functional theory (DFT) utilizing a Micromeritics Gemini VII 2390 Series Surface Area Analyzer.

### Example 8

### Preparation of POSS-HDDA Aerogel in a Mixed Solvent of THF and OS-10 in the Absence of Solvent Exchange

A solution of AIBN (0.53%) initiator was prepared in a 50% (w/w) mixture of THF and silicone fluid (OS-10). MAPOSS and HDDA were mixed at 1:1 molar ratio and dissolved in the AIBN/THF/OS-10 solution to produce a monomer/solvent solution (20 grams total) having a total monomer:solvent ratio of 25:75 with respect to mass. To the above solution 1-decanethiol (21.00 mg) was added and purged with argon gas for 30 minutes. The solution was heated at 90° C. and a white opaque gel was formed without any visible cracks or defects after 5 min. The polymer was further cured for 30 min more at 90° C. The polymer gel was dried in air via evaporation to produce a white and opaque aerogel having a specific surface area of 350 m²/g±3 m²/g as determined by Brunauer-Emmett-Teller (BET) surface area analysis and an average pore diameter of 6.0 nm as determined by Barrett-Joyner-Halenda (BJH) analysis, and a pore volume of 0.54 cm³/g as determined by density functional theory (DFT) utilizing a Micromeritics Gemini VII 2390 Series Surface Area Analyzer.

### Example 9

### Preparation of POSS-HDDA Aerogel in a Mixed Solvent of THF and OS-10 in the Absence of Solvent Exchange

A solution of AIBN (0.53%) initiator was prepared in a 50% (w/w) mixture of THF and OS-10. MAPOSS and HDDA were mixed at 1:1 molar ratio and dissolved in the AIBN/THF/OS-10 solution to produce a monomer/solvent solution (20 grams total) having a total monomer:solvent ratio of 25:75 with respect to mass. The above solution was purged with argon gas for 30 minutes. The solution was heated at 90° C. and a white gel was formed without any visible cracks or defects after 5 min. The polymer was further cured for 30 min more at 90° C. The polymer gel was dried in air via evaporation to produce a white and opaque aerogel having a specific surface area of 250 m²/g±3 m²/g as determined by Brunauer-Emmett-Teller (BET) surface area analysis and an average pore diameter of 6.3 nm as determined by Barrett-Joyner-Halenda (BJH) analysis, and a pore volume of 0.39 cm³/g as determined by density functional theory (DFT) utilizing a Micromeritics Gemini VII 2390 Series Surface Area Analyzer.

### Example 10

### Preparation of POSS-HDDA Aerogel in a Mixed Solvent of THF and OS-10 in the Absence of Solvent Exchange

A solution of AIBN (0.53%) initiator was prepared in binary mixture of OS-10) and THF solvents at 1:1 mass ratio. MAPOSS and HDDA were mixed at 1:1 molar ratio and dissolved in the AIBN/OS-10-THF solution to produce a monomer/solvent solution (20 grams total) having a total monomer:solvent ratio of 25:75 with respect to mass. The solution was heated at 90° C. and hard white opaque gel was formed without any visible cracks or defects after 5 min. The polymer gel was further cured for 30 min more at 90° C. The polymer gel was dried in air via evaporation to produce an opaque aerogel having a specific surface area of 2.50 m²/g±3 m²/g as determined by Brunauer-Emmett-Teller (BET) surface area analysis and an average pore diameter of 6.3 nm as determined by Barrett-Joyner-Halenda (BJH) analysis, and a pore volume of 0.395 cm³/g as determined by density functional theory (DFT).

### Example 11

### Preparation of POSS-HDDA Aerogel in Acetone in the Absence of Solvent Exchange

A solution of lauroyl peroxide (1.6%, LPO) initiator was prepared in acetone solvent. MAPOSS, HDDA and dipentaerythritol penataacrylate were mixed at 1:1:0.25 molar ratio and dissolved in the LPO/acetone solution to produce a monomer/solvent solution (20 grams total) having a total monomer:solvent ratio of 31:69 with respect to mass. To the above solution 1-decanethiol (57.56 mg) was added and purged with argon gas for 30 minutes. The solution was heated at 50° C. and hard transparent gel was formed without any visible cracks or defects after 18 h. The polymer gel was dried in air via evaporation using a restricted drying protocol (2 mil Ziploc bag) to produce a translucent aerogel having a specific surface area of 21 m²/g±3 m²/g as determined by Brunauer-Emmett-Teller (BET) surface area analysis.

### Example 12

### Preparation of POSS-HDDA Aerogel in Isopropyl Alcohol in the Absence of Solvent Exchange

A solution of AIBN (0.75%) initiator was prepared in isopropyl alcohol (IPA) solvent. MAPOSS, HDDA and dipentaerythritol penataacrylate were mixed at 1:1:0.25 molar ratio and dissolved in the AIBN/IPA solution to produce a monomer/solvent solution (20 grams total) having a total monomer:solvent ratio of 34:66 with respect to mass. To the above solution 1-decanethiol (57.00 mg) was added and purged with argon gas for 30 minutes. The solution was heated at 90° C. and hard opaque gel was formed without any visible cracks or defects after 13 min. The polymer was further cured for 30 min more at 90° C. The polymer gel was dried in air via evaporation to produce a white transparent aerogel having a specific surface area of 326 m²/g±3 m²/g as determined by Brunauer-Emmett-Teller (BET) surface area analysis.

### Example 13

### Preparation of POSS-HDDA Aerogel in a Solvent Mixture of NMP and IPA at Varied Ratios in the Absence of Solvent Exchange

A solution of AIBN (0.65%) initiator was prepared in binary solvent mixture of NMP and IPA at a 1:0.5 mass ratio. MAPOSS), HDDA and dipentaerythritol penataacrylate were mixed at 1:1:0.255 molar ratio and dissolved in the AIBN/NMP-IPA solution to produce a monomer/solvent solution (20 grams total) having a total monomer:solvent ratio of 30:70 with respect to mass. To the above solution 1-decanethiol (50.16 mg) was added and purged with argon gas for 30 minutes. The solution was heated at 90° C. and hard transparent gel was formed without any visible cracks or defects after 5 min. The polymer gel was further cured for 30 min more at 90° C. The polymer gel was dried in air via evaporation to produce a white transparent aerogel having a specific surface area of 0.21 m²/gas determined by Brunauer-Emmett-Teller (BET) surface area analysis.

Using this general procedure, POSS-HDDA aerogels were made using NMP and IPA at various ratios. Table 1 lists the ratios of NMP and IPA and the corresponding surface area of the produced aerogel.

TABLE 1

| NMP:IPA Mass Ratio | BET Surface Area m²g⁻¹ |
|---|---|
| 0:1 | 327 |
| 1:9 | 117 |
| 1:8 | 119 |
| 1:7 | 116 |
| 1:6 | 58 |
| 1:5 | 89 |
| 1:4 | 283 |
| 1:3 | 240 |
| 1:2 | 240 |
| 1:1 | 93 |
| 1:0.5 | 0.21 |
| 1:0.25 | 0.21 |

### Comparative Example 1

### Preparation of Hyperbranched POSS Aerogel with Solvent Exchange

A reaction vessel was charged with DMF, POSS structure (III) or structure (IV) (“POSS”), AIBN in a solvent to POSS ratio of 10-30:70. After mixing for 2 minutes, agitation was stopped and the reaction vessel was heated to the desired temperature, in this example 70° C. After 5-30 minutes, the solution had gelled and the gel was allowed to cool to room temperature. The gelled sample was collected and placed into an acetone bath. After immersion for 24 hours, the acetone bath was exchanged for fresh acetone. The soak and exchange process was repeated five times. After the final exchange, the gelled sample was removed and allowed to air dried under flowing air in a fume hood. Using 30 wt. % and acrylic-POSS in ACP, followed by a solvent exchange with acetone (5 times) provided a transparent cross-linked POSS aerogel having a surface area of 440 m²/g. Using 30 wt. % and acrylic-POSS in DMF, followed by a solvent exchange with acetone (5 times) provided a transparent cross-linked POSS aerogel having a specific surface area of 490 m²/g±19 as determined by BET, a BJH average pore diameter of 3.2 nm and a DFT pore volume of 0.34 cm³/g.

### Comparative Example 2

### Preparation of POSS-HDDA Aerogel with Solvent Exchange

A solution of AIBN (0.7%) initiator was prepared in N-methyl-2-pyrrolidone (NMP) solvent. MAPOSS and HDDA were mixed at 1:2 molar ratio and dissolved in the AIBN/NMP solution to produce a monomer/solvent solution having a total monomer:solvent ratio of 30:70 with respect to mass. The above solution was sparged with argon gas for 30 minutes, and sealed. The solution was heated at 90° C. for 34 minutes, and the gel was allowed to cool to room temperature. The gelled sample was collected and placed into an acetone bath. After immersion for 24 hours, the acetone bath was exchanged for fresh acetone. The soak and exchange process was repeated four times. After the final exchange, the gelled sample was removed and allowed to air dry in a plastic jar with a ⅛″ hole in the lid to produce a semitransparent aerogel having a specific surface area of 400 m²/g±3 m²/g as determined by Brunauer-Emmett-Teller (BET) surface area analysis and an average pore diameter of 4.2 nm as determined by Barrett-Joyner-Halenda (BJH) analysis, and a pore volume of 0.33 cm³/g as determined by density functional theory (DFT) utilizing a Micromeritics Gemini VII 2390 Series Surface Area Analyzer.

### Comparative Example 3

### Preparation of POSS-HDDA Aerogel with Chain Transfer Agent and Solvent Exchange

A solution of AIBN (0.7%) initiator was prepared with NMP as solvent. MAPOSS, and HDDA were mixed at 1:1 molar ratio and dissolved in the AIBN/NMP solution to produce a monomer/solvent solution having a total monomer:solvent ratio of 30:70 with respect to mass. To the above solution, 1-decanethiol (31.00 mg, SigmaMillipore, USA) was added, and the solution was sparged with argon gas for 30 minutes, and sealed. The solution was heated at 90° C. for 34 minutes, and allowed to cool to room temperature (e.g., 20 to 35° C.). The gelled sample was collected and placed into an acetone bath. After immersion for 24 hours, the acetone bath was exchanged for fresh acetone. The soak and exchange process was repeated four times. The gelled sample was removed and allowed to air dry in a plastic jar with a ⅛″ hole in the lid to produce a semitransparent aerogel. The aerogel had a specific surface area of 380 m²/g±3 m²/g as determined by Brunauer-Emmett-Teller (BET) surface area analysis and an average pore diameter of 3.6 nm as determined by Barrett-Joyner-Halenda (BJH) analysis, and a pore volume of 0.27 cm³/g as determined by density functional theory (DFT) utilizing a Micromeritics Gemini VII 2390 Series Surface Area Analyzer.

### Comparative Example 4

### Preparation of Hyperbranched POSS Copolymer Aerogel with Multifunctional Chain Transfer Agent and Solvent Exchange

A solution of AIBN (0.7%) initiator was prepared with NMP as solvent. MAPOSS and HDDA were mixed at 1:1 molar ratio and dissolved in the AIBN/NMP solution to produce a monomer/solvent solution having a total monomer:solvent ratio of 30:70 with respect to mass. To the above solution pentaerythritol tetrakis(3-mercaptopropionate) (22.40 mg) was added, and the solution was sparged with argon gas for 30 minutes, and sealed. The solution was heated at 90° C. for 33 minutes, and allowed to cool to room temperature. The gelled sample was collected and placed into an acetone bath. After immersion for 24 hours, the acetone bath was exchanged for fresh acetone. The soak and exchange process was repeated four times. The gelled sample was removed and allowed to dry in a plastic jar with a ⅛″ hole in the lid to produce a semitransparent aerogel. The recovered aerogel had a specific surface area of 470 m²/g±3 m²/g as determined by Brunauer-Emmett-Teller (BET) surface area analysis and an average pore diameter of 3.8 nm as determined by Barrett-Joyner-Halenda (BJH) analysis, and a pore volume of 0.33 cm³/g as determined by density functional theory (DFT) utilizing a Micromeritics Gemini VII 2390 Series Surface Area Analyzer.

### Comparative Example 5

### Preparation of POSS Aerogel with THF Solvent Exchange

A solution of AIBN (0.7%) initiator was prepared with NMP as solvent. MAPOSS, was dissolved in the AIBN/NMP solution to produce a monomer/solvent solution having a total monomer:solvent ratio of 30:70 with respect to mass. Above solution was sparged with argon gas for 30 minutes, and sealed. The solution was heated at 90° C. for 34 minutes, and allowed to cool to room temperature. The gelled sample was collected and placed into a THF bath. After immersion for 24 hours, the THF bath was exchanged for fresh THF. After immersion for 24 hours, the THF bath was exchanged for hexanes. After immersion for 24 hours, the hexanes bath was exchanged for fresh hexanes. The soak and exchange process was repeated five times. The gelled sample was removed and allowed to dry in a plastic jar with a ⅛″ hole in the lid to produce a semitransparent aerogel. The recovered aerogel had a specific surface area of 250 m²/g±3 m²/g as determined by Brunauer-Emmett-Teller (BET) surface area analysis and an average pore diameter of 3.3 nm as determined by Barrett-Joyner-Halenda (BJH) analysis, and a pore volume of 0.17 cm³/g as determined by density functional theory (DFT) utilizing a Micromeritics Gemini VII 2390 Series Surface Area Analyzer.

Thus, aerogels made without solvent exchange provide aerogels with similar properties as those made using solvent exchange. Thus, providing a processing advantage for the production of aerogels in addition to the ability to change the optical properties and surface area properties of the aerogel.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A method of producing an organic polymer aerogel, the method comprising:
(a) polymerizing an organic polymerizable material in the presence of an organic solvent having a high vapor pressure and/or a low boiling point to obtain an organic polymer gel comprising an organic polymer matrix and the organic solvent; and
(b) subcritical or ambient drying the organic polymer gel under conditions suitable to remove the step (a) organic solvent and form an organic polymer aerogel.

2. The method of claim 1, wherein the solvent has a vapor pressure of 15 kilopascal (kPa) to 300 kPa.

3. The method of any one of claims 1 to 2, wherein the solvent has a boiling point of 50° C. to 250° C.

4. The method of any one of claims 1 to 2, wherein the solvent comprises acetone, diethyl ether, tetrahydrofuran, hexane, heptane, a methyl siloxane containing material, a hexamethyldisiloxane containing material, a mixture of fluorocarbon and trans-1,2-dichloroethylene, toluene, o-xylene, m-xylene, p-xylene, a mixture of xylenes, ethyl benzene, mesitylene, a mixture of N-methyl-2-pyrrolidinone and isopropyl alcohol, or combinations thereof.

5. The method of any one of claims 1 to 2, wherein the step (b) drying step is ambient drying.

6. The method of claim 5, wherein the ambient drying step is evaporative drying.

7. The method of claim 5, wherein evaporative drying comprises removing the solvent under a stream of gas at a temperature of 15° C. to 50° C., preferably 20° C. to 30° C.

8. The method of claim 5, wherein ambient drying comprises removing the step (a) solvent without a stream of gas at a temperature of 15° C. to 50° C., preferably 20° C. to 30° C.

9. The method of claim 5, further comprising:
subjecting the organic polymer gel to conditions sufficient to freeze the solvent to form a frozen material; and
subjecting the frozen material to a subcritical drying step sufficient to form the aerogel.

10. The method of any one of claims 1 to 2, wherein step (b) comprises removing the solvent over a period of days.

11. The method of any one of claims 1 to 2, wherein the step (a) polymeric matrix is a polyimide polymer matrix.

12. The method of claim 11, wherein the polymerizable material in step (a) is a mixture of a multifunctional amine, a dianhydride, and a diamine and the polymer matrix is a polyimide polymer matrix.

13. The method of claim 12, wherein the polyimide polymer matrix contains less than 5% by weight of crosslinked polymers.

14. The method of any one of claims 11 to 13, wherein the polyimide polymer matrix comprises a polyamic amide compound.

15. The method of claim 14, further comprising heating the aerogel to convert the polyamic amide to a polyimide.

16. The method of any one of claims 1 to 2, wherein the step (a) polymer matrix is a cross-linked polyester matrix.

17. The method of claim 16, wherein the polymerizable material in step (a) is a mixture of unsaturated polyester compound and least one functionalized compound having an alkenyl group and the polymer matrix is a cross-linked polyester polymer matrix.

18. The method of claim 17, wherein the unsaturated polyester has the general structure of: 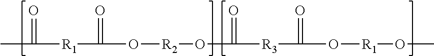
where R₁ is derived from an acid or anhydride moiety, R₂ is derived from a glycol or diol, and R₃ is an alkenyl group moiety capable of reacting with the compound having an alkenyl group to form the cross-linked polyester gel.

19. The method of any one of claims 17 to 18, wherein the alkenyl group is a vinyl group, an acrylate group, or combinations thereof.

20. The method of claim 18, wherein the compound has a vinyl group selected from the group consisting of styrene, 4-vinyl toluene, divinyl benzene, vinyl polyhedral oligomeric silsesquioxane (POSS), and combinations thereof.

21. The method of any one of claims 1 to 2, wherein the step (a) polymer matrix is a cross-linked adamantane matrix.

22. The method of claim 21, wherein the adamantane group is crosslinked with an alkenyl group.

23. The method of any one of claims 21 to 22, wherein the alkenyl group is a vinyl group, an acrylate group, or combinations thereof.

24. The method of claim 23, wherein the compound has a vinyl group selected from the group consisting of styrene, 4-vinyl toluene, divinyl benzene, and combinations thereof.

25. The method of any one of claims 23 to 24, wherein the adamantane group is 1,3,5-trimethacryloyloxy adamantane and the vinyl group is divinyl benzene.

26. The method of any one of claims 1 to 2, wherein the step (a) polymer matrix is a cross-linked POSS matrix.

27. The method of claim 26, wherein the POSS group is crosslinked with an alkenyl group.

28. The method of any one of claims 26 to 27, wherein the alkenyl group is a vinyl group, an acrylate group, or combinations thereof.

29. The method of claim 28, wherein the compound has a vinyl group selected from the group consisting of styrene, 4-vinyl toluene, divinyl benzene, and combinations thereof.

30. The method of any one of claims 26 to 29, wherein the adamantane group is 1,3,5-trimethacryloyloxy adamantane and the vinyl group is divinyl benzene.

31. The method of any one of claims 1 to 2, wherein the aerogel comprises macropores, mesopores, or micropores, or any combination thereof.

32. The method of claim 31, wherein the aerogel has an average pore size of greater than 50 nanometers (nm) to 5000 nm in diameter.

33. The method of any one of claims 1 to 2, wherein step (a) and step (b) does not include a solvent exchange process.

34. A method of producing a polymer aerogel, the method comprising:
(a) reacting a multi-functionalized silsesquioxane (POSS) material with an organic linker group, and optionally a polymerizable organic monomer in the presence of an organic solvent having a high vapor pressure and/or a low boiling point to obtain polymer gel comprising an organically cross-linked POSS polymer matrix and the organic solvent; and
(b) drying the polymer gel under conditions suitable to remove the step (a) organic solvent and form an organically cross-linked POSS polymer aerogel.

35. The method of claim 34, wherein the organically modified multi-functionalized POSS material is:
[R₁—SiO_{1.5}]ₙ,
where:
R₁ is an organic linker group comprising a C₂ to C₁₀ acrylate group, a C₂ to C₁₀ vinyl group, or a C₂ to C₁₀ epoxide group; and
n is between 4 and 12.

36. An aerogel made by the method of claim 1 or claim 34.

37. An article of manufacture comprising the aerogel of claim 36.

38. The article of manufacture of claim 37, wherein the article of manufacture is a thin film, monolith, wafer, blanket, core composite material, a substrate for radiofrequency antenna, substrate for a sunshield, a substrate for a sunshade, a substrate for radome, insulating material for oil and/or gas pipeline, insulating material for liquefied natural gas pipeline, insulating material for cryogenic fluid transfer pipeline, insulating material for apparel, insulating material for aerospace applications, insulating material for buildings, cars, and other human habitats, insulating material for automotive applications, insulation for radiators, insulation for ducting and ventilation, insulation for air conditioning, insulation for heating and refrigeration and mobile air conditioning units, insulation for coolers, insulation for packaging, insulation for consumer goods, vibration dampening, wire and cable insulation, insulation for medical devices, support for catalysts, support for drugs, pharmaceuticals, and/or drug delivery systems, aqueous filtration apparatus, oil-based filtration apparatus, and solvent-based filtration apparatus, or any combination thereof.

39. The article of manufacture of claim 38, wherein the article of manufacture is an antenna.

40. The article of manufacture of claim 38, wherein the article of manufacture is a sunshield or sunscreen.

41. The article of manufacture of claim 38, wherein the article of manufacture is a radome.

42. The article of manufacture of claim 38, wherein the article of manufacture is a filter.

43. A method of producing an aerogel with a selected optical property, the method comprising:
(a) polymerizing an organic polymerizable material in the presence of an organic solvent having a high vapor pressure and/or a low boiling point to obtain an organic polymer gel comprising an organic polymer matrix and the organic solvent, wherein the solvent is selected based on the optical properties of the aerogel; and
(b) subcritical or ambient drying the organic polymer gel under conditions suitable to remove the step (a) organic solvent and form an organic polymer aerogel.

44. The method of claim 43, wherein the optical property is transparency and the solvent comprises an alcohol or ether, preferably isopropyl alcohol.

45. The method of claim 43, wherein the optical property is translucency or opaqueness and solvent comprises an aromatic hydrocarbon or a mixture of an aromatic hydrocarbon and a siloxane containing material, or a mixture of a siloxane containing compound and a an ether.
